(19) United States
(12) Patent Application Publication
(10) Pub. No.: US 2002/0049738 A1
(43) Pub. Date: Apr. 25, 2002

(54) Information collaboration and reliability assessment

(76) Inventor: Bruce A. Epstein, Franklin Park, NJ (US)

Correspondence Address: Jeffrey T. Klayman, Bromberg & Sunstein LLP, 125 Summer Street, Boston, MA, 02110-1618, US

(21) Appl. No.: 09/921,986

(22) Filed: Aug. 3, 2001

Related U.S. Application Data
(60) Provisional application No. 60/222,891, filed on Aug. 3, 2000.

(51) Int. Cl. G06F 7/00

(52) U.S. Cl. 707/1

(57) ABSTRACT

Information collaboration and credibility assessment is based upon a metadata-enhanced database (metabase) that maintains and uses metadata to evaluate the reliability of the metabase information, evaluate the reliability of the metabase users, improve the quality of the metabase information, provide various ancillary services, and provide enhanced browsing functionality. The metabase evaluates the reliability of the metabase information by evaluating the reliability of the metabase users, and evaluates the reliability of the metabase users by evaluating the reliability of the metabase information. A user ranking system is used to generate a relative ranking for each user based upon the metadata. A metadata-enhanced browser uses metadata to provide improved browsing services. A metadata-enhanced robot enables various applications to link to a metabase.

### PRIORITY

The present application claims priority from U.S. Provisional Patent Application No. 60/222,891 entitled INFORMATION SHARING SYSTEM, DEVICE, AND METHOD, filed on Aug. 3, 2000 in the name of Bruce A. Epstein, which is hereby incorporated herein by reference in its entirety.

### FIELD OF THE INVENTION

The present invention relates generally to communication systems, and more particularly to a metadata-enhanced database (hereafter “metabase”) for collaborative sharing and credibility assessment of information in a distributed communication system and other related metadata-enhanced applications.

### BACKGROUND OF THE INVENTION

In recent years, the Internet has exploded to become a premier, and often a primary, source of information. One can find information on practically any subject within the millions of web pages and on-line databases that are accessible over the Internet. The amount of information available over the Internet is almost limitless.

Each Internet site is typically hosted and managed by a central administrator. The central administrator controls the content of the site as well as access to the site for both providing and obtaining information. Because the central administrator has a vested interest in the integrity of the site, the central administrator typically filters and verifies all information that is made available through the site. This is problematic for a number of reasons. Logistically speaking, filtering and verifying all information that is made available through the site is time consuming, and may lead to “stale” information being provided through the site due to the delay caused by filtering and verifying the information by the central administrator. Practically speaking, the central administrator may not be qualified to filter and verify the information that is made available through the site, and therefore the information that is made available through the site may be incomplete or unreliable. Thus, such central administration of the site affects the usefulness of the information that is available through the site.

Also affecting the usefulness of the information that is available over the Internet is the fact that information relating to a particular subject is often available at numerous Internet sites. Very often, the same or similar information is available at multiple sites. Sometimes, the information at one site may conflict with information at another site. The information at a particular site may simply be incorrect or unreliable. Thus, one may need to access multiple sites and wade through duplicate and/or contradictory information, just to obtain a body of information that may or may not be accurate or reliable.

In essence, then, the majority of relevant data is not complicated—it is simply vast and scattered. It is too vast for one person to maintain, too scattered to be readily found by those who seek it, and too disorganized to be quickly assimilated by those that manage to find it. As a result, people are wasting a lot of time creating web pages and on-line databases that include the same information that is already available through other web pages and on-line databases, and are also wasting a lot of time searching for, and processing, information that is distributed throughout the Internet.

One popular solution to these problems (referred to hereinafter as “the search model”) is to allow related information to remain distributed throughout the Internet and to create ever more sophisticated search tools (e.g., web browsers, avatars, robots) in an attempt to find and filter related information. Some web browsers go so far as to give a rating to each site based upon a “perceived” relevance of the site vis-a-vis the user's search criteria, but even such a rating does not truly rate the accuracy or reliability of the information available from the site.

Another popular solution to these problems (referred to hereinafter as “the open source model”) is exemplified by the “open source” software movement. An open source project is one in which the source code is available to anyone who wishes to modify it for his own purposes. The open source nature often leads to a collaborative software development project that is open to many contributors, but the vast majority of users never contribute to the software's development. Although the open source license encourages (or even mandates in some cases) that modifications be made available publicly, there is no guarantee that individual contributions will be incorporated into the “main” version. Although feedback is implicitly provided through testing and editing of the software, and software version control systems are often employed, there is no metadata (i.e., data of an ancillary nature that categorizes or describes other data) inherently captured in the process. Furthermore, the tools available are designed for software development not information gathering.

Therefore, neither model provides accurate, timely, condensed data. The search model suffers, in part, because the volume of information continues to grow faster than the power of the search tools, because it is difficult to evaluate the reliability of information retrieved using the search tools, and because there are no satisfactory mechanisms to categorize the unstructured data. The open source model suffers, in part, because the skill level for creating and editing the software is high, because centralized administration is often required, and because it is difficult to evaluate the reliability of each change to the software (a problem that is compounded by the fact that software code is interrelated, so a change to one area of the software can often affect others areas of the software in unforeseen and unpredictable ways).

One reason for this shortfall in both the search model and the open source model stems from the fact that, generally speaking, web sites, databases, and open source projects are easy to initiate but difficult to populate (i.e., fill with accurate information) and to maintain. Web sites and databases typically place the burden of populating the information on the central administrator, and tend to conceal the underlying data structures and the information itself from the users in order to maintain control of the information in the hands of the central administrator. An open source project places a burden on the central administrator to provide at least an initial software corpus (although the software and its underlying data structures are thereafter open to other contributors), and all contributors are required to have a high level of skill in order to contribute to the open source project (thus leading to a one-way street in which the source code is available, but a contributor's revisions may not be accepted by the administrator). In both cases, even in the best circumstances, there is a significant time lag between the time revisions are submitted and the time these revisions are made public. More commonly, the overwhelming administrative burden causes projects to be abandoned and publicly available data to become obsolete. This leads to user frustration (when a user's contributions aren't published), duplication of effort (when previous contributions are not publicly known and have to be researched again), and suboptimal retrieval of data (users are not notified of newly published data and cannot limit their searches to relevant, well-categorized data).

Another deficiency of both the search model and the open source model is the fact that relevant information that could be used to evaluate the accuracy or reliability of the information is ignored or discarded. Therefore, in the case of a web site or database, users must either trust that the database administrator has provided reliable information or perform an independent analysis of the information. In the case of an open source project, users must either trust that other contributors provided reliable changes to the software or verify the changes, for example, through code inspections or testing. Thus, neither model encourages a novice to create or participate in a project.

Furthermore, even within smaller workgroups or company intranets, similar problems exist and additional problems arise. Typically, no one user has the time or expertise to administrate a database nor the knowledge to populate, edit, or maintain it. Users may not be aware of the credentials or credibility of co-workers and a collaborative data management space is needed when workers are in different geographical locations. Security or privacy concerns may preclude users from collaborating in areas where they share goals that can benefit from a common knowledge pool. Likewise, there are millions of daily conversations that take place among changing groups of participants via email, instant messaging, or chat. The history and resolution of these conversations is impossible to decipher without re-reading the entire transcript (which later-arriving participants won't have the benefit of). These conversations could be more efficiently managed if the evolving conversation created a categorized resolution rather than an unedited transcript.

For these and other reasons, a collaborative information sharing system that is easy to set up, easy to populate with data, easy to use, easy to modify (structurally), easy to maintain, and easy to assess for credibility, is certainly needed.

### SUMMARY OF THE INVENTION

Information collaboration and credibility assessment is based upon a metadata-enhanced database (metabase) that maintains and uses metadata to evaluate the reliability of the metabase information, evaluate the reliability of the metabase users, improve the quality of the metabase information, provide various ancillary services, and provide enhanced browsing functionality. The metabase evaluates the reliability of the metabase information by evaluating the reliability of the metabase users, and evaluates the reliability of the metabase users by evaluating the reliability of the metabase information. A user ranking system is used to generate a relative ranking for each user based upon the metadata. A metadata-enhanced browser uses metadata to provide improved browsing services. A metadata-enhanced robot enables various applications to link to a metabase.

### BRIEF DESCRIPTION OF THE DRAWINGS

The foregoing and other objects and advantages of the invention will be appreciated more fully from the following further description thereof with reference to the accompanying drawings wherein:

FIG. 1 is a block diagram showing relevant logic blocks of an exemplary metadata-enhanced database (metabase) in accordance with an embodiment of the present invention;

FIG. 2 is a network diagram showing a metabase in communication with an independent ranking authority and a user information metabase over a network in accordance with an embodiment of the present invention;

FIG. 3 is a network diagram showing a metadata-enhanced browser (metabrowser) in communication with various external information sources in accordance with an embodiment of the present invention;

FIG. 4 is a logic flow diagram showing exemplary logic for using metadata in a metabase in accordance with an embodiment of the present invention;

FIG. 5 is a logic flow diagram showing exemplary logic for adding a datum to the metabase in accordance with an embodiment of the present invention;

FIG. 6 is a logic flow diagram showing exemplary logic for processing feedback by the metabase in accordance with an embodiment of the present invention;

FIG. 7 is a logic flow diagram showing exemplary logic for evaluating the reliability of a datum in accordance with an embodiment of the present invention;

FIG. 8 is a logic flow diagram showing exemplary logic for evaluating the reliability of a user in accordance with an embodiment of the present invention;

FIG. 9 is a logic flow diagram showing exemplary logic for soliciting feedback and providing additional assistance by the metabase in accordance with an embodiment of the present invention;

FIG. 10 is a logic flow diagram showing exemplary logic for determining whether a user is actively pursuing a datum in accordance with an embodiment of the present invention;

FIG. 11 is a logic flow diagram showing exemplary logic for obtaining missing information by the metabase in accordance with an embodiment of the present invention;

FIG. 12 is a logic flow diagram showing exemplary logic for summarizing metabase information by the metabase in accordance with an embodiment of the present invention;

FIG. 13 is a logic flow diagram showing exemplary logic for automatically creating a FAQ list by the metabase in accordance with an embodiment of the present invention;

FIG. 14 is a logic flow diagram showing exemplary logic for automatically creating an auto-decision tree by the metabase in accordance with an embodiment of the present invention;

FIG. 15 is a logic flow diagram showing exemplary logic for presenting information to a user by the metabase in accordance with an embodiment of the present invention;

FIG. 16 is a logic flow diagram showing exemplary logic for compiling information from multiple information sources by a metadata-enhanced browser (metabrowser) in accordance with an embodiment of the present invention;

FIG. 17 is a logic flow diagram showing exemplary logic for providing page versioning by a metabrowser in accordance with an embodiment of the present invention;

FIG. 18 is a logic flow diagram showing exemplary logic for supporting user attributes by a metabrowser in accordance with an embodiment of the present invention;

FIG. 19 is a logic flow diagram showing exemplary logic for generating a user ranking by the ranking authority in accordance with an embodiment of the present invention; and

FIG. 20 is a logic flow diagram showing exemplary logic for updating user rankings by the ranking authority based upon metadata relating to a datum in accordance with an embodiment of the present invention.

### DETAILED DESCRIPTION OF A PREFERRED EMBODIMENT

The present invention provides an information sharing system that is easy to set up, easy to populate with data, easy to use, easy to modify (structurally), easy to maintain, and easy to assess for credibility. This information sharing system, which uses an approach referred to hereinafter as “the open data model,” separates the initiation of a database project from the data entry and maintenance of the database, including modifications to the structure and content of the database. No particular skill level is required to initiate an open data project, and, for that matter, no particular skill level is required to contribute to an open data project. In fact, the open data project may be open to contributors that are not known a priori. Furthermore, an open data project is easier to manage and administer than an open source project (described earlier), in part because the level of skill needed to update a single datum is often negligible, and there is little risk of an erroneous datum reducing the validity or reliability of other data because one datum is typically independent of other data. Furthermore, the stability of the system as a whole is rarely dependent on the accuracy of a given datum. As a result, an open data project is easier to initiate and maintain compared to, for example, a traditional database or open source project. Administrative tools are provided to facilitate the management of user accounts, privileges, and related tasks.

The open data model utilizes a metadata-enhanced database (metabase) to provide improved information and services to its users. The metabase is populated and maintained by its users. The metabase is so named because it maintains and uses various types of metadata (i.e., data of an ancillary nature that categorizes or describes other data) in addition to the actual information stored in the metabase. Various types of metadata are described in detail throughout the remainder of the specification. It is impossible to provide an exhaustive list of the types of metadata available to the metabase and the uses for the metadata. However, generally speaking, the metadata is used for such things as evaluating the metabase information, evaluating the metabase users, evaluating evaluations of the metabase information and the metabase users, improving the quality of the metabase information, and reducing the volume of obsolete, irrelevant, or conflicting information presented to users. The metabase may modify itself based upon the metadata, for example, in order to improve the organization of the metabase information, eliminate duplicate information, or eliminate unreliable information. Furthermore, it implements mechanisms to allow users to perform these house-keeping chores in cases where the automated procedures are undesirable or insufficient. The metabase provides data and metadata to the users so that the users can evaluate the reliability of the data, and, by doing so, also evaluate the reliability of other users. As data is added to the metabase, the new data affects how earlier data is process or evaluated. This “back propagation” allows data with unknown reliability to be entered into the database and evaluated later based upon subsequent data entries.

A metabase has a number of attributes that makes it useful for collaborative projects. Some of these attributes include identification (the ability to know who contributed data and when the data was contributed), automated version history, notification (the ability to be notified automatically regarding items of interest), categorization (the ability to categorize and store data in a structured way, authorization (the ability to control access privileges), collaboration (the ability to work with others in a shared environment), centralization (the ability to have one up-to-date copy of the data available in real time to all parties), and modification (the ability to modify the structure of the database itself, for example, by creating tables with a database and creating fields within tables, as well as the ability to modify the data itself).

In an exemplary embodiment, the metabase operates in a client-server configuration, where the metabase is essentially a server that is accessed over a communication network (such as the Internet) by any of a number of clients. It should be noted, however, that the metabase is not limited to use over a communication network, but rather can be used in a variety of non-networked applications. For example, a metabase can be used in place of email, where its structure, editability, and automated version control (described below) are useful.

The metabase software may be implemented using a simple scripting language, such as Perl, and any appropriate database engine, such as mySQL. Users access the system via any client-side software that can render HTML, which is most typically a web browser. Unlike some prior art, no browser plug-in is needed, and there is no need to distribute any unique software (the browser itself is sufficient). Any operation performed, including searches, can be “bookmarked” using the standard bookmark feature available in all commercial web browsers, allowing easy access. Furthermore, the user can open multiple browser windows for access to multiple simultaneous features or views. Although the user interface automatically reflects changes to the data entry forms and is configurable via administrative tools, custom user interfaces (UIs) could be implemented to access the metabase and display the data. Datatypes beyond text, including but not limited to graphics, video, and audio, could be incorporated into the metabase. Data could also be delivered in forms that differs from the stored format. For example, text data could be delivered in audible format using text-to-speech technology.

In addition to browser-based access, users often receive notifications via email and can submit contributions via email. Data can also be exported in typical data interchange formats, such as tab-delimited, Microsoft Access, and Microsoft Excel format, appropriate for viewing in other software tools. Delivery could be made to an unlimited number of devices in addition to personal computers, including but not limited to personal digital assistants (PDAs), set-top boxes, gaming consoles, wearable computers, headsets, portable video and audio players, mobile phones, and other stationary and portable devices.

User Accounts and User Administration

Rather than managing the metabase information itself, as in a typical prior art database, the metabase administrator determines the criteria for users to access the metabase and manages the rules by which the users can manipulate the metabase information. The metabase administrator can provide limited or unlimited access privileges to the metabase (e.g., a guest versus a registered user or full administrator). Although user administration tools are provided to help users do things like change their password, change their email notification address, etc., the user administration (in addition to the data administration) can be decentralized by authorizing multiple users with administrative privileges. Even the process by which users are granted administrative privileges can be automated via a ranking authority that periodically revises user privileges based on their expertise and duration of time as a user.

Although anonymous guests may be allowed, typically, the metabase administrator requires that each metabase user be identifiable, for example, using a user-identifying mark (e.g., name, email address, domain name, personal web site identifier, digital certificate, Internic ID handle, Verisign certificate, PGP key, assigned identifier). Identification of users is encouraged as it aids in the collection of metadata, but is not mandatory. Users who wish to remain anonymous could use an “anonymous” login, and would typically be granted fewer privileges than an identified user. New users are typically authorized to create their own accounts, although administrators may wish to establish guest or public accounts (or eliminate the need for a login password altogether) to reduce administrative hassles due to novice or one-time users who have difficulty creating accounts for themselves.

The open data model decentralizes administration insofar as users can be granted the rights to delete or create databases, tables, records, and fields (or even entire sites that host various metabases). A metabase administrator may also impose certain restrictions as to which users can contribute information to the metabase as opposed to which users can retrieve information from the metabase. Access can be controlled at all levels of granularity. For example, users can be denied access or granted read, write, or delete privileges for fields within a record, records within a table, tables within a database, databases within a project, and projects within a site. Users can be authorized for multiple metabase sites, or access can be limited to a single site containing one or more metabases. Users can be given or denied the privilege to create new items, edit existing items from other users, or delete items (created either by themselves or other users). The privileges can be set with considerable granularity. Users can be granted the privilege to, say, add fields and records, but not delete existing fields and records. Likewise, users can be granted privileges to import data from, say, another database, but not given privileges to export data (or vice-versa).

Privileges can be controlled for individuals, a group of individuals, multiple groups, or across all users. For example, when a record is created, the contributor can specify whether the record will be private to himself, semi-private for people in his group, or public to all users. Likewise, the administrator can control which users/groups can access or edit each field in the database (or fields can be hidden entirely). Users can be granted different levels of privileges by being assigned to a group. For example, users in the “basic” group might be allowed to view data but prevented from editing it, and users in the “advanced” group might be allowed to delete records or perform other destructive actions. In the preferred embodiment, a single user could be part of multiple groups in which case he might be granted the highest privileges of all the groups of which he is a member. Each group can be authorized to access one or more “views” of the data. Each user within a group can customize his view of the data within the constraints of the privileges granted to him. For example, a user could choose not to see things which are not of personal interest, but wouldn't have the option to view things for which he doesn't have the needed privileges. New users are typically provided a separate group password to use when creating their accounts. Authorized users can also change the group to which they are assigned provided that they know the group username and password (which differs from their unique personal login and password). An administrative tool is also provided to allow authorized users to assign or reassign other users to different groups. Users not assigned to a privileged group may be given basic default privileges or denied access altogether. A group username and password may grant various privileges to users at both the site level and the database level. For example, it may grant the group members the right to create new databases. It might also grant them read-only access to some databases and read/write access to other databases. A user need not be assigned to the same group for all databases; they might be part of one group for the purposes of database A and part of a different group for the purposes of database B. In the preferred embodiment, the metabase software automatically tracks which users are part of which groups for each databases, and allows authorized users to change groups as described earlier. Administrators can change the privileges granted to a group at any time; the privileges of each group member are updated automatically.

User identification is typically “abstracted” so that a user's account name (or similar identifying mark) is not the same as the user's email address. That way, if the user's email address changes, the user's identity and user ranking remains intact. Likewise, if a username is a “role alias” such as “Accounts Receivable,” the person behind the alias can change without affecting other users.

Mechanisms are implemented to ensure that users do not receive unsolicited email. Users can set preferences to indicate such things as whether they want to accept automated email notification (this can be set using several criteria for each database table defined), whether to allow other users to contact them directly, whether to receive email using plain text or HTML, etc.

Authorized users may be given direct access to the information stored in the metabase as well as to the underlying data structures. Access is typically in real time with no intervening delay between submission and the time that contributions are published, although off-line, batch, import, and export modes are supported for users without active network connections. Authorized contributors may manipulate the information in the metabase in almost unlimited ways, including, but not limited to, adding information to the metabase, deleting information from the metabase (although a version history is kept of deleted items), editing information in the metabase, adding new fields to the metabase, and modifying the structure of the metabase itself (such as changing the choices represented by popup menus, checkboxes, and radio buttons).

Authorized users can upload and download “attachments” (i.e. documents) to be associated with an individual record. Users uploading attachments can set privileges for whether those attachments can be viewed and/or deleted by other users (privileges can be set separately for the contributor, other users in the same group, users in other groups, all identified users, or all users including guests).

The preferred implementation also embodies the concept of “projects” in which records from different database tables can be grouped under a single unifying entity. This allows different database tables to represent various needs (for example, one for bug reports, another for feature suggestions, etc). The user can add the desired type of record to the project which then would “contain” records from one or more tables. This allows different data entry forms to be associated with a single project.

Furthermore, users can search across multiple records in a project (even if those records are stored in different database tables) or across multiple projects. When searching across multiple tables, the search form is configurable to show fields that are unique to a given table or show fields common across all tables being searched. A full text search of all content in all tables is also implemented, as are multiple search criteria, such as searching by contributor, modification date, keywords, etc.

Populating the Metabase

In an open data project, a single metabase administrator neither populates nor verifies information that is included in the metabase, except as a user of the metabase. A user adds a new datum to the metabase by entering information in an on-line datum entry form provided by the metabase. An exemplary data entry form (i.e., a metabase record) includes such things as one or more datum entry fields, plus fields to qualify the data, such as a category field, a confidence level field, and an importance level field. Typical field types are supported, such as single-line text fields, multi-line (scrolling) text fields, radio buttons, checkboxes, popup menus, date fields, time fields, and numeric fields (integer and floating-point number with minimum and maximum allowed ranges). Unique field types include URL fields and notification fields (the latter causes selected parties to be notified when their username is chosen from the field via checkboxes or a popup menu). Each database table typically includes a user identification field and modification date/time field that is preferably populated automatically by the metabase (and like other fields may be hidden from certain users). Preferably, the user does not enter extensive user identification information, but rather enters only a user-identifying mark (e.g., name, email address, domain name, person web site identifier, digital certificate, Internic ID handle, Verisign certificate, PGP key, assigned identifier). The metabase may maintain additional user information that can be accessed using the user-identifying mark, or the metabase may obtain additional user information using the user-identifying mark, for example, from another metabase.

When a datum is added to the metabase, the metabase creates a record for the datum. In addition to the datum itself, the record typically includes such things as user identification metadata identifying the datum contributor; user personal information associated with the datum contributor; datum modification date; information characterization metadata (e.g., information category, confidence level, importance level); status metadata (e.g., unverified, yet to be disputed); and metabase-specific metadata (e.g., record number, grouping information, record order information).

A version history (i.e., a revision history) is kept automatically, allowing users to view and compare differences between any two revisions of a given record.

Thereafter, the metabase acquires various types of metadata pertaining to the datum. One way that the metabase acquires metadata is from user accesses to the metabase. A user may access the metabase for various reasons, including, but not limited to adding a new datum; clarifying an existing datum; commenting on an existing datum; revising an existing datum; amending or updating a datum to address an omission; adding a link to related information (e.g., if a user reaches datum A and then accesses irrelevant data B, C, D, and E before reaching relevant datum F, the user can add a link from datum A to datum F so that subsequent users can proceed directly from datum A to datum F so as to skip irrelevant data B, C, D, and E); adding a link to supplemental information (e.g., adding a URL to a related web site); adding a keyword to be used in future metabase searches; adding a review or rating to a datum (e.g., important, unimportant, general information); adding a user skill level tag for a datum (e.g., beginner, intermediate, advanced, expert), adding a date tag for a datum (although this is typically automated); adding an expiration date to a datum (e.g., an actual date, a software version number); adding a classification to a datum (e.g., product, operating system, problem area, problem severity); querying an existing datum; disputing an existing datum; escalating an ongoing dispute; arbitrating an ongoing dispute; calling for a vote regarding the reliability of the datum; voting to approve the datum; voting to disapprove the datum (with or without making a correction); and retrieving information from the metabase.

Escalation and arbitration call on one or more third-party users to resolve a dispute, for example, using a successive appellate process similar to a court system in which a “jury” of users can vote, and the resulting vote can be appealed to a higher level.

Unlike the prior art, in a typical open data metabase, a metabase allows for tremendous specificity of revisions/collaboration, insofar as edits can be made to the content submitted by other users. Such revisions can be made at any level of detail. For example, instead of creating a new record, a user can revise an existing record to correct grammar and spelling errors. Likewise, a user could add a comment to an existing record, add their ascent to an existing statement, offer a contrary view, or delete another user's submission entirely (because it may be off-topic, useless, inflammatory, or was entered in the wrong place by accident).

When a record is modified in some way, the original version of the record becomes part of the version history of the “current” incarnation. The metabase also allows the creation of “child records” which are not revisions to the current record, per se, but instead intended for related information, like for a threaded discussion or peripheral issues. Furthermore, when a record or the database structure itself is modified, interested users are notified via email, which provides both a link to the revision and an accounting of the revisions made (or other action taken) and by whom. For example, interested parties might be notified that user “John” had changed the value of a given field in an existing record or that user “Bob” had created a new record. Users can be notified of different events, such as modifications to records (additions, changes, deletions), modifications to the field structure (new fields, edited fields, and deleted files), among other things. Furthermore, a typical embodiment includes automated mechanisms for users to notify each other. For example, a so-called “notification” field that contains usernames of other users can be created. Whenever a name is chosen from the notification popup menu, that user is notified. Furthermore, the list of names that appear in a popup menu can be drawn from a list of users in one or more groups. For example if a group called “Engineering” (with 6 users in it) was included in a notification field, a popup menu would be created using the names of all 6 users in the Engineering group. If the membership in the group changed, the popup menu would be updated automatically to reflect the group membership. It should be noted that notification fields can also take on different forms, such as checkboxes and radio buttons in addition to popup menus.

Each time a user accesses the metabase, the user explicitly or implicitly provides metadata to the metabase. This is true whether the user is contributing information to the metabase or retrieving information from the metabase.

The types of metadata that are available to the metabase are almost limitless. Examples include user identification metadata (e.g., name, email address, domain name, personal web site identifier, digital certificate, Internic ID handle, Verisign certificate, PGP key, assigned identifier); user personal information metadata (e.g., education, employment history, research interests, personal experiences, reputation); user performance metadata (e.g., contribution history, contribution reliability); information characterization metadata (e.g., information category, confidence level, importance level); source metadata (i.e., first-hand information or second-hand information, and if second-hand, a citation to the source); feedback metadata (e.g., edits to existing information, deletions of existing information, reasons/explanations for editing or deleting information, comments relating to the usefulness or reliability of the information, annotations to the information, links to related information in the metabase, links to supplementary information outside of the metabase, votes or opinions as to the reliability of information, cross-references to duplicate information); implicit metadata (e.g., the information accessed by a user, the order in which a user accesses the information, the time spent by a user on a particular datum); and historical metadata (e.g., revision history and the number of accesses to a particular datum).

Even the reason why a user accesses the metabase is a useful piece of metadata. Other types and examples of metadata are discussed throughout the remainder of the specification.

In order to track each unit of metadata separately (e.g., contributor, date, feedback from other users), the metabase preferably stores each such unit of metadata as a subrecord of the original record (that is, it associates a complete revision history containing both data and metadata for each contribution with each record). Each subrecord includes its own metadata so that the subrecord can be placed in context with the original record and the other subrecords.

Thus, a full record for a particular datum (including the original record and all subrecords) includes such things as user identification metadata including the original contributor of the datum, subsequent contributors to the datum (e.g., editors, commentators, annotators), and other users that are interested in the datum (used for revision history and automated notification); user personal information metadata (e.g., education, employment history, research interests, personal experiences, reputation, qualifications with respect to a particular subject matter, user ranking, opinions of other users, contribution history to one or more metabases); information characterization metadata (e.g., information category, confidence level, importance level); source metadata (i.e., first-hand information attributable to the contributor, second-hand information attributable to someone other than the contributor and citation to the second-hand source); feedback metadata (e.g., user reviews/ratings, user comments, user annotations, links to other data, links from other data); implicit metadata (e.g., information accessed by each user, the order in which each user accesses the information, the time spent by each user on the datum); historical metadata (e.g., the number of accesses to the datum); version metadata (e.g., modification history); status metadata (e.g., verified, unverified, disputed, undisputed, yet to be disputed); statistical metadata (e.g., overall credibility rating, adjusted credibility rating); and metabase-specific metadata (e.g., record number, grouping information, record order information).

A key aspect of the metabase, and one that distinguishes the metabase from a traditional database, is that the metabase information can be modified by authorized users after it is added to the metabase. Specifically, new information may be added to the metabase or existing information may be modified at any time. The metabase maintains a history of metabase changes, but otherwise does not require that the changes be verified before being made to the metabase. Although this theoretically permits unreliable information to be included in the metabase, tests show that the benefits of open data collaboration outweigh the potential drawbacks. Although users often make accidental errors when submitting data, these are easily corrected by other users; maliciously false or fraudulent data have not been encountered during limited tests. The privilege mechanisms and automatic history tracking allow even novice users to contribute without accidentally destroying data. Benefits of the open data model include the fact that it makes information available immediately with minimal administrative oversight (i.e., it doesn't require a dedicated administrator to post updates). This fosters user participation and a sense of community ownership in a public resource. The reliability of a datum can be evaluated either manually by other users or automatically using metadata as discussed throughout the remainder of the specification. Disputes can arise as to the reliability of a datum, and such disputes can be resolved using metadata as discussed throughout the remainder of the specification. If necessary, users can view the historical record to trace the origins of any dispute. Abusive users (detected by heuristics or by reports from other users) can have their privileges revoked if necessary.

Although the metabase administrator may limit access to the metabase via administrative tools, a metabase is typically “open” in that any metabase user can provide metadata to the metabase, particularly in the form of feedback (e.g., edits to existing information, comments relating to the usefulness or reliability of the information, annotations to the information, links to related information in the metabase, links to supplementary information outside of the metabase, votes or opinions as to the reliability of information). This feedback is used to evaluate the metabase information, evaluate the metabase contributors, and even evaluate the user providing the feedback, as described throughout the remainder of the specification.

In essence, then, the reliability of the metabase information is evaluated by evaluating the reliability of the metabase users, and the reliability of the metabase users is evaluated by evaluating the reliability of the metabase information. Regardless, in many applications, even incomplete or erroneous information may point users in the right direction. For example, a contributor might suggest a command but misspell its name. Not only can another user of the information probably discover the misspelling and figure out the correct command, he can also fix the erroneous information in the metabase for the benefit of future users. This constant refinement of data works particularly well where an existing community of users collaborates to create a knowledgebase. Not only is the cost of erroneous information sometimes low, the open data model allows for a full debate of complementary or competing solutions.

Because the structure of the database can itself change (i.e. fields can be modified, added, or deleted) allowances are made to automatically modify the existing data to conform with the revised database structure. For example, if a field is deleted from a database table, the corresponding data is deleted from all the records. If a new field is added, it can be populated with a default value in all existing records. If the contents of a popup field are modified, a user can specify rules by which existing data is modified to conform to the new popup menu choices.

Evaluating Metabase Information

One use for the metadata is for evaluating the reliability of the metabase information. As described above, the metabase does not require changes to be verified before being made to the database, and therefore the metabase may include unreliable information. However, the metadata may give a clue to the reliability of each datum.

One key reliability indicator for a particular datum is the contributor or source of the datum. An exemplary metabase accrues metadata regarding the contributor of each datum, such as a user identifier, user personal information, and source (i.e., first-hand or second-hand with citation). While such metadata does not necessarily determine the reliability of a particular datum, it does give some indication as to the reliability of the datum. For example, one may be willing to trust the reliability of a datum provided by a particular individual or by an individual having certain qualifications (e.g., one may be willing to trust the reliability of a datum provided by a noted expert in a particular subject matter, absent any contradictory information, but unwilling to trust the reliability of a datum provided by a novice, absent other corroborating information). For second-hand information, both the contributor and the cited source are evaluated using the metadata. It should be noted that the qualifications for a particular contributor or source are relative to a particular metabase or subject matter, so that an individual may be an expert for the purposes of one metabase but a novice for the purposes or another metabase. Again, this level of granularity is an important improvement over the prior art. For example, a particular book reviewer may develop a high-ranking reputation for reviews of computer books (as judged by other users), but this same reputation may not apply to the reviewer's reviews of different types of books, such as cooking or philosophy.

Another reliability indicator for a particular datum is the opinion of the contributor as to the reliability of the datum. An exemplary metabase accrues metadata regarding the contributor's opinion as to the reliability of the data, for example, in the form of an information category (e.g., product information, operating system information, problem area, problem severity), a confidence indication (e.g., certain, uncertain, verified, unverified, tested, untested, factual, disputed, undisputed, yet to be disputed, rumor, likely, unlikely, assumption, presumption, intended by design), an importance indication (e.g., important, unimportant), and even the reason why the user accesses the metabase. While such metadata does not necessarily determine the reliability of a particular datum, it does give some indication as to the reliability of the datum. For example, another user may have less confidence in the reliability of a datum if the datum's contributor is uncertain as to the reliability of the datum. Allowing a contributor to express a confidence level for his contributions has important benefits over the prior art. Testing of prior art databases (most notably bug reporting systems) revealed that users would not submit questionable or partial information for fear of providing useless data, thereby wasting their time and damaging their reputation. The open data model eliminates these impediments, allowing users to submit “rough” bug reports for hard-to-reproduce bugs. Other users were able to “triangulate” the problem to produce a well-defined reproducible set of steps to replicate the bugs. This helped to resolve precisely the bugs that prior art systems failed to catalog, namely transient bugs that were hard to replicate in traditional quality assurance testing but were sporadically detected by beta-testers. Furthermore, the decentralized administration inherent in the open data model allows software developers to expand the number of beta test sites without being inundated by poor quality bug reports. A hierarchy of skilled users filter and refine the incoming submissions (without requiring dedicated staff from the software developer). Furthermore, because beta-testers can view and edit the records contributed by others, there is less duplication of effort and fewer redundant bug reports. Furthermore, because testers often refine a bug report over time until a conclusion is reached, the revision history of the record can often be ignored. An engineer fixing a software bug may only need to read the final bug report rather than the multiple contributions that eventually led to the final conclusive report. These features of the preferred embodiment allow software developers to “cast a wider net” to detect more obscure or transient software defects with less administrative overhead and greater reliability compared to the prior art.

Yet another reliability indicator for a particular datum is the opinion of other users as to the reliability of the datum. An exemplary metabase accrues metadata regarding the reliability of the datum, particularly in the form of feedback from the users. While such metadata does not necessarily determine the reliability of a particular datum, it does give some indication as to the reliability of the datum. For example, one may be willing to trust the reliability of a datum that is approved by a particular individual or by an individual having certain qualifications (e.g., one may be will to trust the reliability of a datum approved by a noted expert, absent any contradictory information, but unwilling to trust the reliability of a datum approved by an unknown novice, absent other corroborating information). It should be noted that the qualifications for a particular user are relative to a particular metabase or subject matter, so that an individual may be an expert for the purposes of one metabase but a novice for the purposes or another metabase. That said, unlike the prior art, the metabase does not require or assume that an individual contributor must have a particular skill level before contributing. Because the metabase ranking authority and community policing provide both implicit and explicit feedback, a merit-based reliability factor is quickly derived for each contributor.

Still another reliability indicator for a particular datum is the combined opinions of multiple users as to the reliability of the datum. The opinions of multiple users may be used to evaluate the reliability of the datum through “consensus building.” An exemplary metabase determines an overall credibility rating for the datum based upon the user opinions. In the absence of a consensus, a user (or the metabase itself) can call for a vote as to the reliability of the datum, and any disputes can be escalated or arbitrated. While such metadata does not necessarily determine the reliability of a particular datum, it does give some indication as to the reliability of the datum. For example, one may be willing to trust the reliability of a datum having a high overall credibility rating but unwilling to trust the reliability of a datum having a low overall credibility rating. It is important to note that, as in real life, there is not necessarily a single universal credibility rating for a datum. A user can customize his ranking authority's algorithm to weight judgements by other contributors as he deems desirable. Therefore, a consensus may be reached not by a simple plurality of opinion, but a weighted average of the opinions the user chooses to deem relevant.

Evaluating Metabase Users

Another use for the metadata is for evaluating the metabase users. The metabase users implicitly, and even explicitly, evaluate each other through use of the metabase. The users implicitly evaluate the reliability of the contributor of the datum as well as the reliability of other users' evaluations of the datum by evaluating the reliability of the datum itself (e.g., a consensus as to the reliability of a particular datum reflects upon the reliability of the contributor of the datum as well as the reliability of other users who evaluated the datum). The users may also explicitly evaluate the reliability of the contributor of the datum as well as the reliability of the other users' evaluations (e.g., by commenting directly on the integrity of other users as well as on the reliability of other users' evaluations). In order to reduce antagonism or false statements, some administrators may choose not to allow users to directly evaluate other users. Instead, such evaluation would be calculated indirectly based on user's assessment of each other's data. For example, instead of saying “I think John is stupid,” a user might state, “John is mistaken when he asserts that the Earth is flat.” Each user even implicitly evaluates him/herself through the user's own history with various other metabases (e.g., a user's “track record” with other metabases reflects upon the user's reliability in general and hence the user's reliability within a particular metabase). For example, if a user submits all his contributions with the highest “importance” rating, another user might infer that the first user is alarmist or unable to prioritize. On the other hand, if a user submits all his contributions with the lowest confidence level, another user might infer that the first user suffers from a lack of confidence or is too impatient to research his statements more thoroughly.

Thus, a body of information is accrued for each metabase user. The accrued body of information reflects upon the overall reliability of the user. Such user reliability information is itself metadata that can be used to make further evaluations.

One use for such user reliability information is for evaluating the relative reliability of each user's opinion. For example, user opinions can be weighted based upon the perceived reliability of each user's opinion. Opinions from users with low rankings may be given little weight, while opinions from users with high rankings may be given great weight. The weighted opinions may be used to generate an adjusted (weighted) credibility rating for the datum according to a predetermined (or adjustable) weighting scheme.

Another use for such user reliability information is for normalizing a user's opinion against the user's own history. The user's history reflects upon the reliability and credibility of each subsequent contribution and opinion provided by the user. For example, if a user has lied in the past, then subsequent contributions from the user may be considered unreliable. If a user consistently gives above-average ratings, then the user may simply be a “high scorer,” in which case one might discount a high rating from the user as simply another high score. Similarly, if a user consistently gives below-average ratings, then the user may simply be a “low scorer,” in which case one might discount a low rating from the user as simply another low score.

Yet another use for such user reliability information is for normalizing a user's opinion against the opinions of other users. A statistical analysis may be used to determine the reliability of a particular user opinion. For example, consider the reliability of reviews of buyers and sellers on auction sites such as eBay.com. If a user gave extremely favorable reviews to a vendor who garnered highly negative reviews from other users (or vice-versa) it might indicate an ulterior motive on the part of the reviewer. Again as an improvement over prior art, this would help detect “shills” who provide false reviews of products or vendors. (Cases of such intentional misrepresentation on the internet are well-documented.)

In an exemplary embodiment of the invention, a ranking system is used to summarize the overall reliability of each user. Specifically, a ranking authority (which can be part of the metabase itself or an independent of the metabase) uses the various forms of metadata to determine and maintain a ranking for each user. The user ranking may take on various forms, such as a relative value from 0 to 100 or a skill level (e.g., novice, proficient, expert, master) in one or more areas of assessment. The user ranking is based upon such things as education, experience, reputation, qualifications with respect to a particular subject matter, contribution history to one or more metabases, and others' evaluations of the user's past contributions to one or more metabases. A user's ranking represents a relative confidence level in the user, and is therefore useful metadata in and of itself for evaluating both the user's contributions to a metabase and the user's feedback regarding other users of the metabase. A user's ranking may be relevant to a particular metabase or across multiple metabases depending on the similarity in topics. Metabase users can define a correlation coefficient when considering a user ranking derived from another metabase. For example, an expert's ranking in a metabase dedicated to medicine might earn him a high rank in another metabase dedicated to biology, but would most likely have no relevance to his credibility in a metabase focused on music.

The ranking authority dynamically adjusts user rankings as metadata is obtained and processed. The ranking authority may increase a user's ranking, for example, upon determining that the user contributed reliable information to a metabase. The ranking authority may decrease a user's ranking, for example, upon determining that the user contributed unreliable information to a metabase. The ranking authority may adjust the magnitude of any increase or decrease in the user's ranking based upon other metadata. For example, a user may receive little or no penalty for contributing unreliable information that was contributed with a low confidence level, but may receive a large penalty for contributing unreliable information that was contributed with a high confidence level. In this way, contributors are not penalized for contributing partial or incorrect information to the metabase so long as they acknowledge its potential for being erroneous. This leads to the benefits described earlier insofar as allowing a metabase to capture vague or loosely defined statements that are able to be confirmed or refined later by other users.

In addition to evaluating metabase information and metabase users, the user ranking may be used for other metabase functions. For example, the user ranking may be used to evaluate the metabase administrator or to choose a metabase administrator (i.e., to grant privileges). Also, when arbitration is needed to resolve a dispute, the user ranking may be used to select an appropriate arbitrator from among the community of users. The user ranking can also be used to “lock out” a particular user from the metabase (i.e., to revoke privileges to prevent intentional abuse such as “SPAM” (unwanted commercial solicitations)). This represents several important advances over the prior art. By providing administrative privileges to skilled and responsible users, the metabase embodiment of the open data model guarantees that there is not a single point of failure (i.e., a single administrator). Should the original “owner” of the metabase become unavailable or unwilling to maintain the metabase, other users can fulfill the administrative role. Conversely, the administrators do not need to police abusive users because other users, or the system itself, can remove irrelevant submissions or revoke a user's privileges. Consider the analogous situation with, say, a prior art “mailing list”: If the administrator goes on vacation, there may be no one to authorize new users or revoke a user's privileges. If SPAM (unsolicited commercial email) is sent to the list, each user receives a copy and must delete it himself. In contrast, the preferred embodiment of the metabase open data model allows any authorized user to act as the administrator. Furthermore, any authorized user can delete unwanted submissions, which are then deleted from the centralized repository and don't need to be deleted by each user manually.

It is even envisioned that the user ranking will take on a more ubiquitous role in evaluating the user outside of the realm of an open data project. For example, the user ranking may replace or be used in conjunction with resumes, job referrals, certifications, and other applications where a user assessment is required. The ranking authority may generate a user ranking certificate including such information as an overall ranking, a contribution history (e.g., the metabases accessed by the user and the information contributed), and various statistics (e.g., percentage of verified contributions, percentage of unchallenged contributions, percentage of challenged contributions, percentage of incorrect contributions). Again, this offers much greater granularity than prior art that allows only a single rating (such as one to five stars) or a binary evaluation (such as approval/disapproval).

Such alternative uses of the user ranking actually benefit the open data community because users have an incentive to contribute reliable information to metabases in order to improve their respective rankings. Although it is impossible to provide an exhaustive list of the ways in which the metabase uses metadata to evaluate users, numerous other applications are envisioned, including evaluation of users in areas besides their knowledge level, such as consumer preferences, personality assessment, and creditworthiness.

A new user to the metabase can use the various user rankings and other metadata to gain knowledge about the reputation of existing participants. Thus, the metabase transfers knowledge of other persons gained from the experience of existing participants. Users can then assess and value the information as they choose. For example, if other users have repeatedly categorized a particular user's contributions as “off-topic” (i.e. unrelated to the stated purpose of the discussion), a new user can ignore contributions from the undesirable contributor.

Improving Metabase Information

One purpose for the metabase is to amass reliable information and provide the information to the users in a useful form. The nature of a metabase permits unreliable information to be included in the metabase, and also permits information to be entered in an unorganized manner. Therefore, the metabase uses the various types of metadata to improve the quality and usefulness of the metabase information. Although it is impossible to provide an exhaustive list of the ways in which the metabase uses metadata to improve the quality and usefulness of the metabase information, some examples are described below.

One way that the metabase uses metadata to improve the quality and usefulness of the metabase information is by notifying users when information is modified so that changes can be evaluated quickly. The metabase maintains a list of all users that are interested in a particular datum. In an embodiment of the invention, all contributors to the datum (i.e., the original contributor and subsequent editors, commentators, and annotators) are presumed to be interested in the datum. Other interested users may be added to the notification list upon request. When the datum is modified (e.g., edited or even deleted), the metabase informs all interested users, for example, through email. The email typically includes a reference or link to the relevant record (or web page) plus a description of the modifications performed. In this way, the interested users are afforded an opportunity to evaluate the modification without having to continually monitor the metabase for changes. Notification preferences are completely configurable by users and administrators. A user can be notified at any interval (such as in real time, daily, weekly, or monthly) and can customize the notification criterion. For example, a user may choose to be notified only when a date field indicates that something has expired. Independent of any user contributions, automated reports can be periodically generated using any criterion, such as modification date, contributor's name, etc. Users can manually “forward” data of interest to other registered users or to any third-party email address (thus allowing non-registered users to also benefit from or participate in the project).

Another way that the metabase uses metadata to improve the quality and usefulness of the metabase information is by soliciting feedback from active users of the metabase. When a user accesses the metabase, the metabase provides an opportunity for the user to provide feedback regarding the metabase. In one exemplary embodiment of the invention, the metabase provides an on-line feedback form to the user, for example, when the user is finished with a particular datum or finished using the metabase. In another exemplary embodiment of the invention, the metabase sends an email message to the user inviting the user to respond with feedback information. In order to solicit feedback from only those users who actively use the metabase, the metabase may provide a way for the user to pursue a particular datum (e.g., a “pursue it” click button) and provide only those users that pursue data an opportunity to provide feedback. This allows time for the user to, for example, test the suggestions provided by the metabase before deciding whether they were in fact useful in solving the problem. This improves over prior art that either does not solicit feedback or solicits feedback immediately (at a time when the user may not have the necessary knowledge to evaluate the information). For example, if a database provided driving directions, the user wouldn't know until he arrived at the destination whether the driving directions and estimated travel time were accurate. Upon arrival, the user could better evaluate the information obtained from the database and would possibly have additional information to contribute, such as an alternate route suggested by someone at the destination. Because the metabase actively solicits feedback rather than requiring the user to initiate it, the user is more likely to provide feedback.

Yet another way that the metabase uses metadata to improve the quality and usefulness of the metabase information is by actively soliciting for missing information. The metabase can identify missing information and contact the appropriate individual(s) to obtain it. For example, when a software defect (i.e., a bug) is entered into a bug-reporting metabase for a particular platform, the metabase can request that an appropriate person check other platforms for the same bug or request that the bug report contributor check other platforms for the same bug. The metabase can periodically issue status reports to interested parties that indicate missing data. The metabase may also solicit for missing information arising out of changes to the database structure. For example, when a new field is added to a metabase table (and no data has been filled in for the field in existing records) the metabase could solicit the original contributors of each record to also provide a datum for the newly-added field.

Still another way that the metabase uses metadata to improve the quality and usefulness of the metabase information is by providing additional assistance based upon the user's feedback. The metabase obtains feedback in many ways, such as an on-line feedback form or email. If, for example, a particular user indicates that the metabase information is incomplete or confusing, or the user indicates a desire for additional information, the metabase may notify someone who can provide additional information.

Still another way that the metabase uses metadata to improve the quality and usefulness of the metabase information is by consensus building. When the metabase identifies a datum having an undetermined status (e.g., because there is an insufficient amount of opinion metadata for the datum or there is a dispute over the reliability or appropriate value of the datum), the metabase can actively pursue a consensus for the datum. For example, the metabase can inform the users that more opinions are needed, assign an arbitrator to resolve a dispute, or even call for a vote as to the reliability of the datum (and then tally the vote).

Still another way that the metabase uses metadata to improve the quality and usefulness of the metabase information is by identifying and eliminating duplicate or redundant information. The metabase can filter the metabase information to identify duplicate or redundant information. The metabase may compare each datum to the existing data in the metabase, for example, when the datum is added to the metabase or as a background task in order to identify duplicate information or information likely to be redundant. The metabase may identify duplicate or redundant information based upon feedback from the users. For example, the metabase may provide an opportunity for a user to verify or comment on information. The metabase may leave the redundant information in the metabase, in which case the metabase marks the datum as being redundant, or the metabase may remove the redundant information from the metabase. The metabase also alerts users to potential redundancies and facilitates removal or reduction of redundancies. Thus, when a reader intends to submit a new record, the metabase typically searches the existing records for similar records, for example, based upon similar keywords or fields set to identical values. The metabase may provide a “redundancy warning” to the user upon detecting similar records and present the potentially related records to the user. The metabase typically gives the user an opportunity to either submit the record “as is” or resolve any redundancy, for example, by deleting the record, combining the records, or collating the potentially redundant or related records. This reduces the unnecessary creation of multiple redundant records in a more sophisticated way than, for example, simply ensuring that a single field is unique.

Still another way that the metabase uses metadata to improve the quality and usefulness of the metabase information is by eliminating unreliable information. The metabase can identify unreliable information, for example, by consensus. The metabase may leave the unreliable information in the metabase, in which case the metabase marks the datum as being unreliable, or the metabase may remove the unreliable information from the metabase. Regardless, the modification history and metadata are retained, so that the data can be displayed according to the user's preferences.

Still another way that the metabase uses metadata to improve the quality and usefulness of the metabase information is by grouping related information. The metabase uses various types of metadata (e.g., category information, importance information, links) to identify related information. The metadata can then manipulate the related information as a group. For example, the metabase may place the related datum contiguously within the metabase, evaluate the information together, and present the information to the users together.

Still another way that the metabase uses metadata to improve the quality and usefulness of the metabase information is by presenting the data in a logical order based upon predetermined or user-specified criteria. The metabase can change the order in which the metabase information is accessed or retrieved based upon any criteria (e.g., category, importance, access frequency, chronological, group, or contributor). The metabase may select a static order for the metabase information or dynamically tailor the order of the metabase information for a particular user, for example, based upon user preferences or user-specified criteria. The metabase may skip duplicate, redundant, and unreliable information (as determined using any of a variety of criteria), so as to avoid presenting useless or unwanted information to the user. It should be noted that the metabase does not simply return search results, but instead empowers the users to define how and what they want to view. This is typically not even possible in a prior art database. For example, a prior art web site may provide some predefined ways to sort book reviews, but the user typically cannot sort them by the user's own ranking criteria, such as by the names of the contributors.

Still another way that the metabase uses metadata to improve the quality and usefulness of the metabase information is by providing the user with relevant information about each datum. When the user accesses a particular datum, the metabase can provide useful information to the user, such as the status of the datum (e.g., verified, disputed, yet to be disputed), the overall credibility rating of the datum, or other users' opinions of the datum. Such information helps the user to evaluate the datum independently of the other data.

Ancillary Services

In addition to improving the quality and usefulness of the metabase information itself, the metabase can provide any number of ancillary services. Although it is impossible to provide an exhaustive list of ancillary services, some examples are described below.

One exemplary ancillary service involves summarizing metabase information. The metabase can generate summaries of varying scope based upon the metadata. For example, the metabase can generate an abstract including only the most important information or a brief summary including a broader range of information. The metabase can also generate a summary that is customized to a particular user's criteria. For example, a user may request a summary of biographical information and receive from the metabase only biographical information. Reports can be generated periodically (in real time, daily, weekly, monthly) and delivered in any format, such as an HTML-based web page, a database file (such as tab-delimited or Microsoft Access format), or other format (such as Microsoft Excel).

Another exemplary ancillary service involves generating a list of the most frequently asked questions and the corresponding answers (often referred to as a “FAQ” list). In general, it is easy to identify frequently asked questions and their responses, but time-consuming to construct a FAQ list. However, it is easy for the metabase to construct such a FAQ list because the metabase already maintains the information and the related metadata that is needed to construct the FAQ list.

With respect to a FAQ list, the metabase provides certain value-added services that are not provided by other FAQ applications. For one example, the metabase can refer a user to the FAQ list, and even to a specific FAQ entry, when the user poses a question that has already been answered. For another example, the metabase can adjust the order of the FAQ list to move the more frequently asked questions to the top of the FAQ list. For yet another example, the metabase (by virtue of the metadata maintained by the metabase) can identify a particular user, the last time the user accessed the FAQ list, and the FAQs accessed by the user at that time, and present to the user only those FAQs that have been added or updated since the user's last access to the FAQ list. For still another example, the metabase may provide a mechanism by which a user can jump from a particular FAQ directly to a relevant “user group” (i.e., single-topic discussion forum available on the Web) in order to obtain additional information or clarification. As with other metabase information, the users can provide feedback on the FAQs, and the metabase updates the FAQ list as it does with other metabase information.

Still another exemplary ancillary service involves creating an auto-decision tree. An auto-decision tree is essentially a “knowledgebase” for solving a particular problem. The metabase builds the auto-decision tree based upon user queries, user responses, metabase information, and metadata. For example, a metabase may be established for compiling computer-related problems and their possible solutions, and the metabase can automatically establish an auto-decision tree to recommend actions based upon user problems (e.g., if the user indicates that the computer will not start, the metabase may query whether the user has the computer plugged into an outlet and suggest a course of action based upon the user's response).

Still another exemplary ancillary service involves coordinating so-called “off-line” discussions. With users contributing to the metabase, providing feedback to the metabase, disputing information, and trying to resolve disputes, one can imagine certain situations when the status of a particular datum is in flux and the metabase resources are being used for bickering rather than for true information gathering and evaluation. In an exemplary embodiment of the invention, the metabase provides a way for one or more users to force an off-line discussion. The metabase may even initiate the off-line discussion itself if it detects counterproductive behavior (such as two users repeatedly changing the value of a field back and forth to impose their opinions). The metabase may support and enforce the off-line discussion, for example, by indicating that the datum is associated with an off-line discussion and by deflecting all users that access the datum to the off-line discussion forum. The metabase may automatically disable the ability to edit a datum to prevent excessive volatility, or it may automatically escalate an issue for arbitration.

Still another exemplary ancillary service involves providing a way for the users to form special interest groups. The metabase may provide a way for a user to “spin off” a special interest group (e.g., a mailing list, chat room, web page, or even a new metabase) from a particular datum. The subject matter of the special interest group may or may not be related to the datum itself. In either case, the metabase includes a link from the datum to the special interest group so that subsequent users of the datum at least know that the special interest group exists. This reduces potential sources of “noise” that plague many existing shared information forums.

Improving Information Retrieval

The metadata permits the metabase to provide information to the user in various forms. Thus, users have a great deal of control over information retrieved from the metabase. More than just specifying the content and format of the data, the users can essentially configure the metabase to customize information retrieval. Although it is impossible to provide an exhaustive list of ways to customize information retrieval, some examples are described below.

One example of such customization is version control. Each user can retrieve any desired version of the metabase information and compare different versions easily (differences may be shown in underline, strike-through text, in a different color, etc.). Versions can be defined by various criteria (e.g., date, contributor, category, confidence, importance, credibility ratings, user opinions, user ranking). For one example, the user can retrieve the current version of information that includes all edits made by a particular contributor on a particular date that have achieved a specific credibility rating. For another example, the user can choose to retrieve only information approved by a particular person or ignore all information disapproved by a particular person. For yet another example, the user can choose to ignore information contributed by anyone having a low ranking. For still another example, the user can retrieve all information that relates to a particular product or platform (e.g., retrieve all bugs that are in a particular operating system version). For still another example, the user can retrieve all information that may be related to a particular product or platform (e.g., retrieve all bugs that have not been ruled out for a particular operating system version). In essence then, there is not necessarily a definitive “current” version of the data, but rather a fluid mechanism for deciding which data the user considers relevant. It should be noted that the user may be permitted to view “deleted” information as well as current information. This so-called “deleted” information may no longer be crucial to the current discussion, but may provide interesting background information. It also prevents a user's edits from unintentionally removing meaningful data permanently. Users can “roll back” revisions to return a database record to a prior state.

Another example of such customization is user preferences. Each user can configure personal preferences for retrieving information. The preferences can be for an individual datum, a group of data, the entire metabase, and even across metabases. For example, the user may configure the metabase to provide information in a particular order (e.g., for an address/phone number metabase, always display the record for Fred Jones first when the search criteria is “Jones”). Preferences can be configured for all views of the data, whether the so-called “table of contents”, search results, reports, or other views.

Yet another example of such customization is user-defined filtering. Each user can specify filters that define a repetitive course of action for some data. The user can configure the metabase to perform a specific filtering function on data meeting certain criteria. For example, a user might choose to view only those items assigned to himself and then sort the results by the due date.

The Metabrowser

Web browsers are better than metabases at finding information across multiple sites. Combining metabase functionality with browser functionality into a metadata-enhanced browser (metabrowser) essentially provides the best of both worlds. The metabrowser can be a metabase that is enhanced with browser functions, a browser that is enhanced with metabase functions, or a new entity that includes both functions.

A primary function of a metabrowser is to pull together multiple information sources, such as web pages, databases, and metabases. The metabrowser can use the multiple information sources to provide more information and more options to the users. Although it is impossible to provide an exhaustive list of metabrowser-enhanced functions, some examples are described below.

One exemplary metabrowser-enhanced function enables information from multiple information sources to be physically or logically integrated into an existing metabase. The metabrowser can actively scan the multiple information sources for relevant information and copy the information into the metabase. The metabrowser treats such information like any other metabase information. For example, the metabrowser maintains metadata for the information, enables the information to be edited, enables the information to be evaluated based upon the metadata, and enables the information to be retrieved based upon user specifications. The infrastructure for facilitating this communication is described later under “EDITABLE DATA MARKUP LANGUAGE (EDML).”

A similar result can be obtained through the use of a metadata-enhanced robot (metabot). A metabot is a program that is generated by a metabase for use by other metabases, metabrowsers, and traditional web browsers. These other metabases, metabrowsers, and traditional web browsers obtain the metabot, for example, by linking to the metabase (e.g., by creating a bookmark to the metabase). The metabot dynamically retrieves information from its parent metabase for its host. For example, a metabase that contains zip codes and area codes can publish a metabot that is automatically downloaded as a “meta-bookmark” when another metabase, metabrowser, or web browser links to the metabase. The metabot updates zip code and area code information for its host, for example, by periodically retrieving information from the parent metabase or retrieving the information on-demand.

Another exemplary metabrowser-enhanced function enables the metabrowser to act as a sort of super metabase for multiple information sources by creating a metabase from information obtained from the multiple information sources (e.g., the metabrowser compiles information from a number of web sites). The metabrowser treats such information like any other metabase information. For example, the metabrowser maintains metadata for the information, enables the information to be edited, enables the information to be evaluated based upon the metadata, and enables the information to be retrieved based upon user specifications. The metabrowser can even create a web page containing the information obtained from the multiple information sources.

Yet another exemplary metabrowser-enhanced function is referred to hereinafter as “page versioning.” In essence, page versioning enables a user to retrieve multiple instances of a single web page. Currently, when a user accesses a particular web page, the user retrieves whatever information is contained in the web page at that time. The information contained in the web page may change after the user accesses the web page. When the user “refreshes” the web page, the user retrieves the updated information, but loses access to the previous information. With page versioning, the metabrowser caches previous instances of the web page so that the previous instances remain available to the user. For example, the metabrowser can cache the last ten days of a newspaper web page (e.g., the “front page”) for future reference or to analyze the differences between successive incarnations of a web page. Thus, the metabrowser can provide information and services that aren't ordinarily provided by the web site of interest (or other data source).

Yet another exemplary metabrowser-enhanced function provides for customized browsing. For example, the user can set browsing attributes per web page or web site (e.g., disable automatic image downloading for one web site but enable automatic image downloading for other web sites).

Still another exemplary metabrowser-enhanced function performs automatic sorting of “bookmarks” (e.g., according to URL or other criteria).

Editable Data Markup Language (EDML)

In order to promote the use of metabases (and metabrowsers), an Editable Data Markup Language (EDML) is proposed for use in creating and using metabases. EDML is envisioned as an alternative or replacement for other markup languages, such as the SGML or XML, which define custom document type definitions (DTDs) for data exchange but don't implement an API (application programmer interface) or define the functionality to be supported by the client.

EDML defines rules for creating and editing metabase structures, contributing information to the metabase structure, and retrieving information from the metabase structure. EDML also supports and enables the various ancillary services (e.g., summarize information, create a FAQ list, create an auto-decision tree, coordinate off-line discussions, facilitate formation of special interest groups) and metabrowser services (e.g., integrating multiple information sources, act as a super metabase for multiple information sources, page versioning, customized browsing, bookmark sorting).

An exemplary EDML has certain attributes. For example, EDML preferably utilizes a modular architecture including a replaceable security layer, replaceable ranking authoring, etc. Also, the EDML application program interface (API) library is preferably replaceable. These and other attributes permit user upgrades without affecting the underlying metabase.

An exemplary EDML allows two or more metabases to be treated as if they are a single metabase. For example, using EDML, a user could pull data from multiple metabases hosted on different servers and make them appear to be a single metabase. This approach addresses inefficiencies introduced when multiple sites set up “competing” databases that would better be treated as a “natural monopoly.” For example, if two separate metabases contained list of Windows error codes, the information would be more complete and less redundant if it was consolidated into a single metabase. Therefore EDML-compliant metabases could be combined seamlessly according to the open data mechanisms described earlier. The consolidation could take place without modifying the original source metabases. Instead, the consolidated metabase would pull the new information as necessary from the source metabases and maintain its own metadata as needed.

Business Models

Not only does the open data model provide numerous information sharing advantages, but it also provides numerous business-related advantages and opportunities. Although it is impossible to provide an exhaustive list of business-related advantages and opportunities, some examples are described below.

A primary advantage of the open data model is that the metabase accrues more complete and accurate information compared to a traditional database or web site. This is useful for stand-alone metabases and metabrowsers, but may also be useful as a component of some other product. Therefore, metabase functions can be added to other products in order to enable those products to accrue more complete and accurate information.

Another advantage of the open data model is reduced maintenance costs for the metabase host. The metabase host can initiate an open data project by simply specifying the subject matter to be contained in the metabase, and then allowing the users to define the metabase structure and populate the metabase. This provides an incentive for people to start new open data projects, and also provides an incentive for existing databases and web pages to be converted into metabases. Inevitably, potential metabase hosts will require help in converting existing databases and web pages into metabases. A separate metabase consulting company is envisioned to provide such consulting services.

Because the metabase administrator can limit access to the metabase, there is substantial value in the metabase information itself. Thus, the metabase information can be leveraged, for example, by selling the metabase information or selling access to the metabase information.

Similarly, there is substantial value in the metadata that is maintained and obtained by the metabase. Thus, the metadata can be leveraged, for example, by selling the metadata or selling access to the metadata. Thus it could be used as the basis of a job placement agency, a certification program, a credit-reporting agency, insurance underwriting, health insurance management, or similar business in which the qualifications, attributes, or reputation of the participants are relevant.

Similarly, the metabase has substantial value in that it can be used to produce and manage large volumes of data contributed by many users, making it ideal for technical support, bug-reporting databases, and knowledgebases. It can be used to manage software development and testing, replace a technical support help desk, and replace or augment mailing lists, threaded message boards, newsgroups, and other technical support forums. Thus it has substantial value in reducing support costs, improving software quality, and increasing customer satisfaction and loyalty. Incorporation of instant-messaging (i.e. chat) functionality with complete tracking of the transcript, which will further enhance productivity, is also envisioned.

Furthermore, the metabase itself has substantial value, in part, because of the incentives for people to contribute and use the metabase. Thus, the metabase can be leveraged, for example, by providing free access to contributors and users but charging advertisers to advertise on the metabase pages and forms.

The metabase's open data model and automated notification allow it to manage any workflow that can be embodied by a series of steps, tasks, or procedures. Therefore, the metabase has substantial value as a workflow management tool. For example, each metabase record could indicate a task to be performed, who it is assigned to, the due date, and the status, among other things. As each step in the process is completed, the next party to whom the task is assigned will be automatically notified. The system could generate reports showing the status of each task, the tasks assigned to each worker, the due date for each task, and other status information.

Metabase Applications

The open data model can be used in an almost endless number of applications. Those who initiate an open data project or convert a traditional database to a metabase enjoy lower maintenance costs while obtaining more complete and accurate data. Those who use a metabase gain recognition, a sense of community, and access to more complete and accurate data. Although a metabase can be used for sharing all kinds of information, it is particularly useful for verifiable (factual) information due to the way in which metabase information is evaluated. That said, its ability to incorporate vague or contradictory information makes it useful for discussions of a multi-faceted nature. Although it is impossible to provide an exhaustive list of metabase applications, exemplary metabase applications include, among other things, a central repository of user information accessed by a user-identifying mark, such as for storing user personal information metadata for use by multiple metabases; a central mailing list used by multiple organizations, in which each person updates his or her own contact information (e.g., name, address, phone numbers, data of birth, email address); a “person book” (i.e., an address book based not on addresses, but on identities) that automatically retrieves current information for the people listed in the book, for example, from a central mailing list metabase for magazine subscriptions or an email forwarding service); generic lists (e.g., computer error codes, error reasons/solutions, file types, file extensions, gestalt codes, compatible software for a particular operating system, compatible plug-ins for a particular application program, postal (zip) codes, area codes, international calling codes); a list of bugs for a particular product or project; a “wish list” of new features for a particular product; user-maintained classified advertisements; statistics (e.g., baseball statistics, award winners, weather, almanac); a language dictionary (e.g., including slang terms, abbreviations, footnotes, commentary, usage, classifications, cross-references to related terms, cross-references to synonyms, cross-references to antonyms, common misspellings); a reverse dictionary; a knowledge base for research projects (e.g., disease research, human genome project, astronomy); a catalog of books (e.g., ISBN, author, availability); a catalog of videos and movies (e.g., actors, director, running time); a catalog of computer software (e.g., CD-ROMs, games, product reviews); a catalog of music recordings (e.g., catalog number, composer, performer, availability, media); and product comparisons.

Metabases containing personal information work well, in part, because each person is presumed to be the most qualified to update his or her own personal information (e.g., name, address, phone numbers, date of birth, email address, etc.), although other people might provide updates.

Exemplary Embodiments

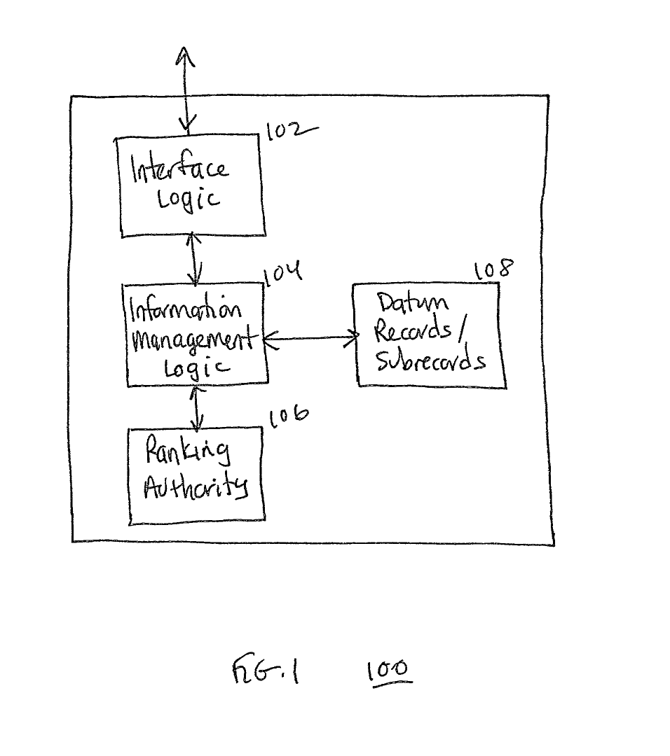

FIG. 1 is a block diagram showing relevant logic blocks of an exemplary metabase 100. Among other things, the metabase 100 includes interface logic 102, information management logic 104, a ranking authority 106, and datum records/subrecords 108. The metabase 100 interfaces to users and other information sources through the interface logic 102. The information management logic 104 obtains data, feedback, and other information from users via the interface logic 102, and stores data and metadata in datum records/subrecords 108. The information management logic 104 provides various types of metadata to the ranking authority 106, which generates user rankings based upon the metadata provided by the information management logic 104. In order to evaluate the reliability of the metabase information, evaluate the reliability of the metabase users, improve the quality of the metabase information, and provide various ancillary services and enhances browser services, the information management logic 104 obtains various types of metadata from the ranking authority 106 and the datum records/subrecords 108.

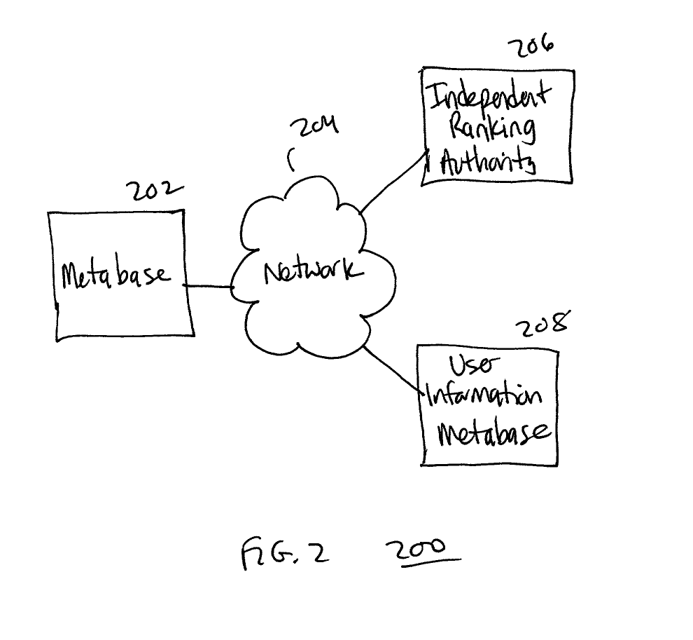

FIG. 2 is a network diagram showing a metabase 202 in communication with an independent ranking authority 206 and a user information metabase 208 over a network 204. The metabase 202 performs various metabase functions as described herein. The independent ranking authority 206 generates user rankings for use by other metabases. The user information metabase 208 maintains user personal information for use by other metabases. The metabase 202 utilizes user ranking metadata obtained from the independent ranking authority 206 and user personal information obtained from the user information metabase 208 in addition to other metadata maintained by the metabase 202. The metabase 202 and the user information metabase 208 provide metadata to the independent ranking authority 206 for use in determining user rankings. The metabase 202 and the independent ranking authority 206 provide metadata to the user information metabase 208 for updating user personal information maintained by the user information metabase 208. It should be noted that the user information base 208 could be stored itself in an editable metabase.

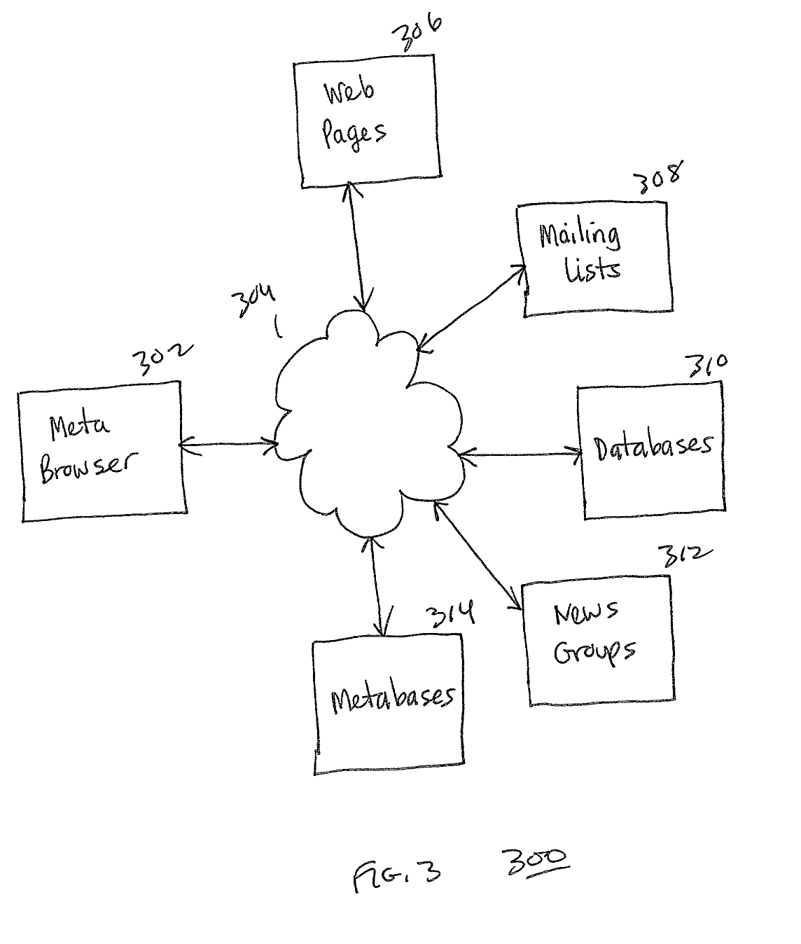

FIG. 3 is a network diagram showing a metabrowser 302 in communication with various external information sources over a network 304. The external information sources include web pages 306, mailing lists 308, databases 310, news groups 312, and other metabases 314. The metabrowser 302 can retrieve and integrate information from the multiple external information sources.

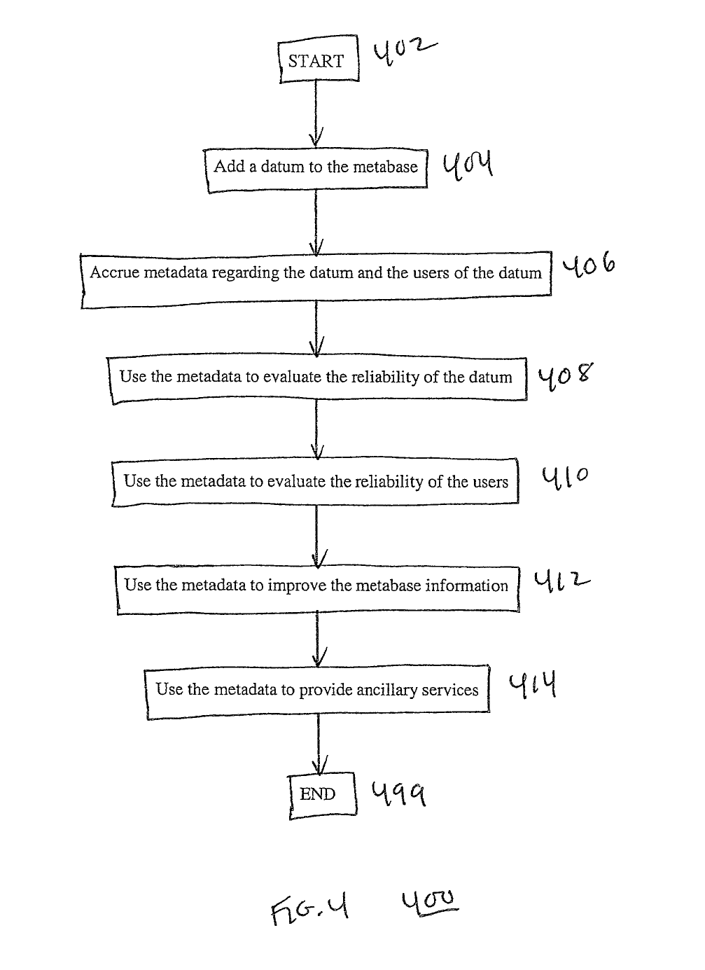

FIG. 4 is a logic flow diagram showing exemplary logic 400 for using metadata in a metabase. Beginning at step 402, the logic adds a datum to the metabase, in step 404, and accrues metadata regarding the datum and the users of the datum, in step 406. The logic uses the metadata to evaluate the reliability of the datum, in step 408. The logic uses the metadata to evaluate the reliability of the users, in step 410. The logic uses the metadata to improve the metabase information, in step 412. The logic uses the metadata to provide various ancillary services, in step 414. The logic 400 terminates in step 499. It should be noted that the logic can improve and evaluate the data at any time, including at the time the data is submitted and at the time the data is served to the user.

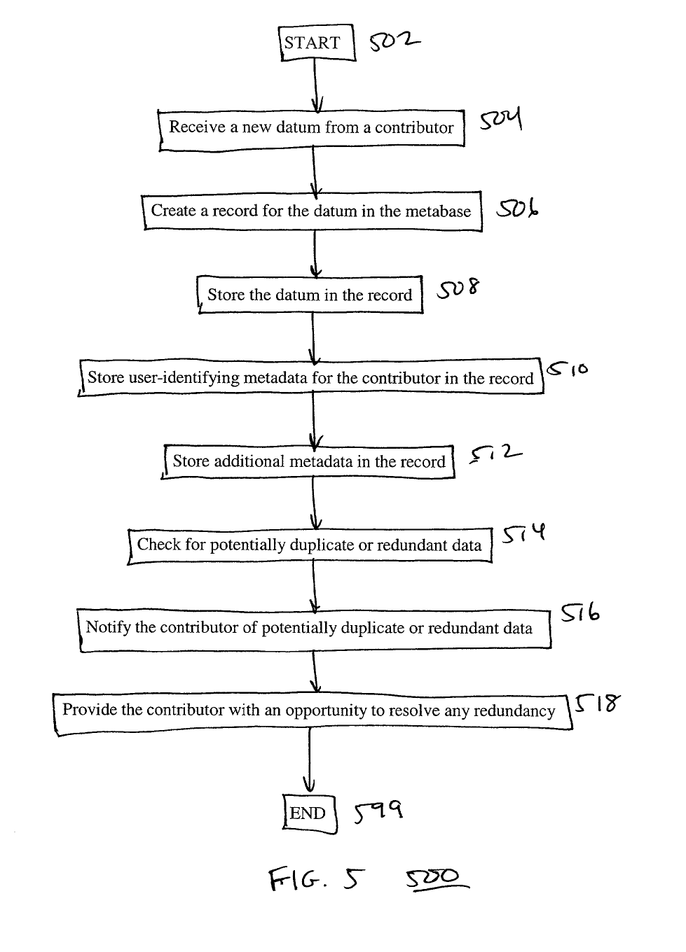

FIG. 5 is a logic flow diagram showing exemplary logic 500 for adding a datum to the metabase. The logic begins at step 502, and upon receiving a new datum from a contributor, in step 504, the logic creates a record for the datum in the metabase, in step 506. The logic stores the datum in the record, in step 508, and stores user-identifying metadata for the contributor in the record, in step 510. The logic also stores additional metadata, provided by the contributor or otherwise, in the record, in step 512. The logic may check for potentially duplicate or redundant data, in step 514, and upon identifying potentially duplicate or redundant data, may notify the contributor, in step 516, and provide the contributor with an opportunity to resolve any redundancy, in step 518. The logic 500 terminates in step 599.

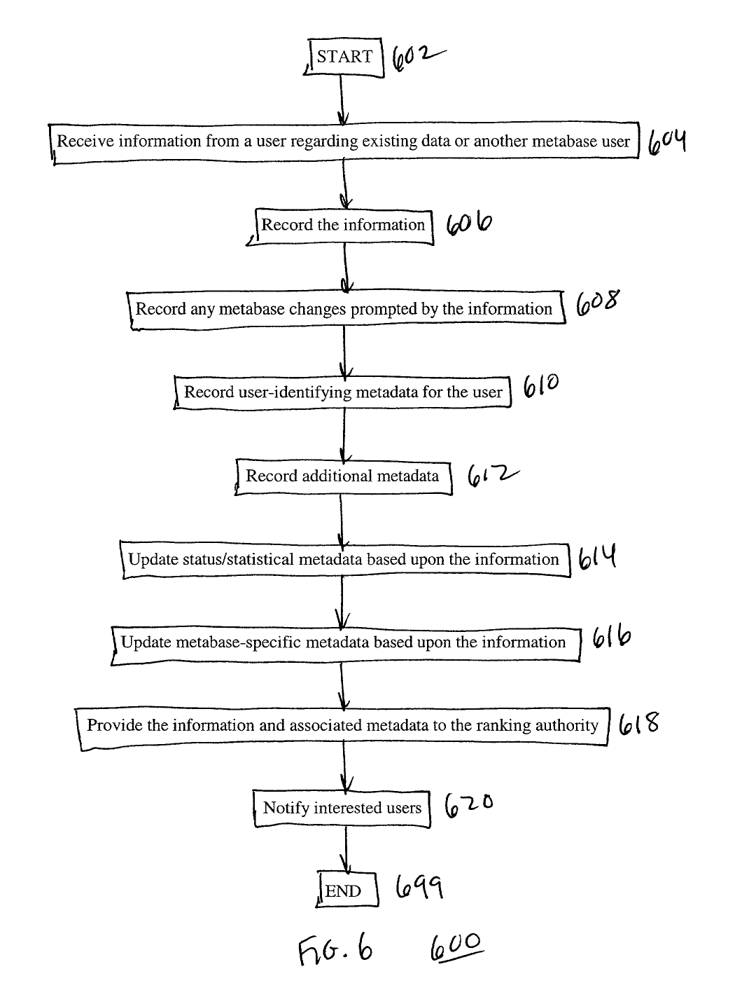

FIG. 6 is a logic flow diagram showing exemplary logic 600 for processing feedback by the metabase. The logic begins at step 602, and upon receiving information from a user regarding existing data or another metabase user, in step 604, the logic records the information, in step 606. The logic records any metabase changes prompted by the information, in step 608, and records user-identifying metadata for the user, in step 610. The logic also records additional metadata, provided by the user or otherwise, in step 612. The logic updates status/statistical metadata based upon the information, in step 614. The logic updates metabase-specific metadata based upon the information, in step 616. The logic provides the information and associated metadata to the ranking authority, in step 618, so that user rankings can be updated. The logic may notify interested parties, in step 620, for example, via email. The logic 600 terminates in step 699.

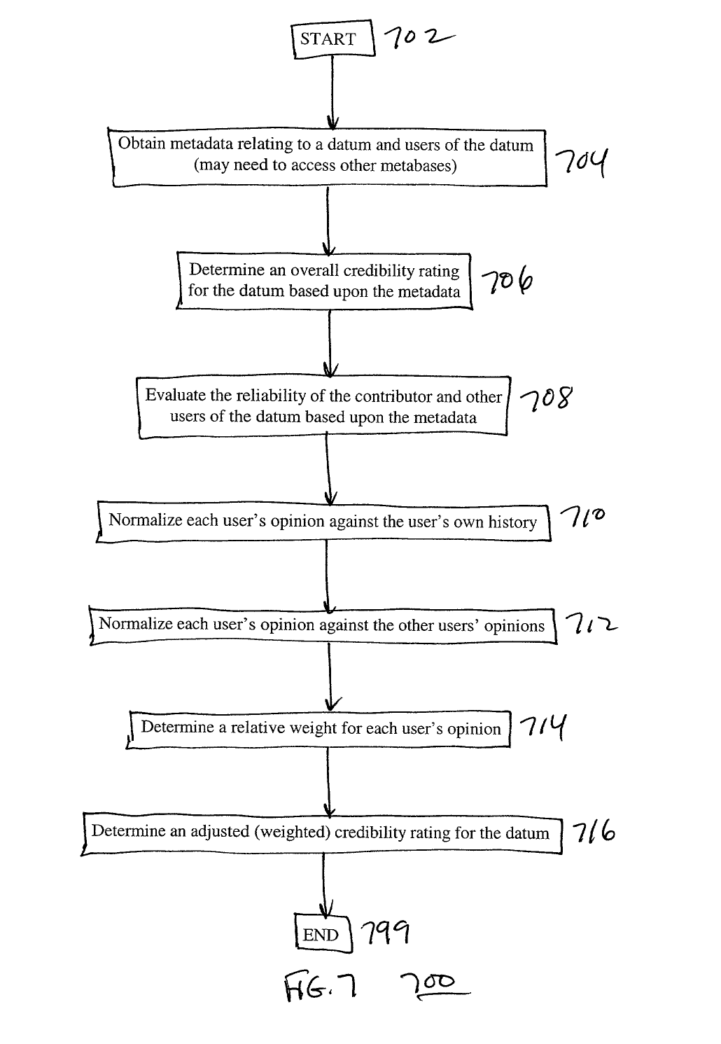

FIG. 7 is a logic flow diagram showing exemplary logic 700 for evaluating the reliability of a datum. Beginning at step 702, the logic obtains metadata relating to a datum and users of the datum, in step 704. The logic may obtain certain metadata from other metabases or other external information sources. The logic determines an overall credibility rating for the datum based upon the metadata, in step 706. The logic may also proceed to evaluate the reliability of the contributor of the datum as well as the other users of the datum based upon the metadata, in step 708. This may involve normalizing each user's opinion against the user's own history, in step 710, as well as normalizing each user's opinion against the other users' opinions, in step 712. Based upon these evaluations, the logic determines a relative weight for each user's opinion, in step 714, and determines an adjusted (weighted) credibility rating for the datum, in step 716. The logic 700 terminates in step 799.

It should be noted that, in a typical embodiment of the invention, there typically is not just one current rating or “current version” of a record based on normalization (see steps 710 and 712). Rather, different users may choose to configure their ranking authorities differently and/or to ignore certain user's entries. For example, a user might choose to see data that has been entered by identifiable users but ignore data entered anonymously or by guests. Thus the metabase provides a customized output based on the user's requests rather than serving up the same data to all users.

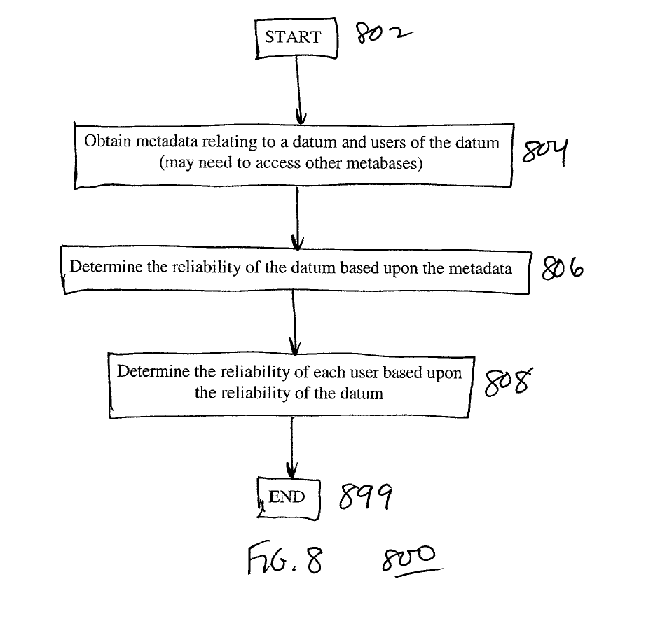

FIG. 8 is a logic flow diagram showing exemplary logic 800 for evaluating the reliability of a user. Beginning at step 802, the logic obtains metadata relating to a datum and users of the datum, in step 804. The logic may obtain certain metadata from other metabases or other external information sources. The logic determines the reliability of the datum based upon the metadata, in step 806. The logic determines the reliability of each user based upon the reliability of the datum, in step 808. The logic 800 terminates in step 899.

It should be noted that, in a typical embodiment of the invention, there is does not necessarily need to be a consensus to judge the reliability of a given contributor or datum. Instead, the metabase provides some guidance, but the ultimate interpretation is left to the user. Even without a consensus, a user can rate another user's claims. That said, a negative vote from a low-ranking user might not carry much weight. Therefore, even the “consensus” will most likely not be by simple plurality. Instead, one super-knowledgeable user's claim might outweigh the votes of all other user's combined. For example, in a group discussion regarding a bug in a software program, a user may choose to believe the opinion of the programmer even if fifty other people claim something contrary. In the absence of a consensus, a user may choose to view contradicting statements along with identifying metadata in order to make an independent determination regarding reliability. Thus the metabase can be particularly useful in evaluating information in cases where there is no consensus. It can then show inconclusive or conflicting information and let the user decide what to do.

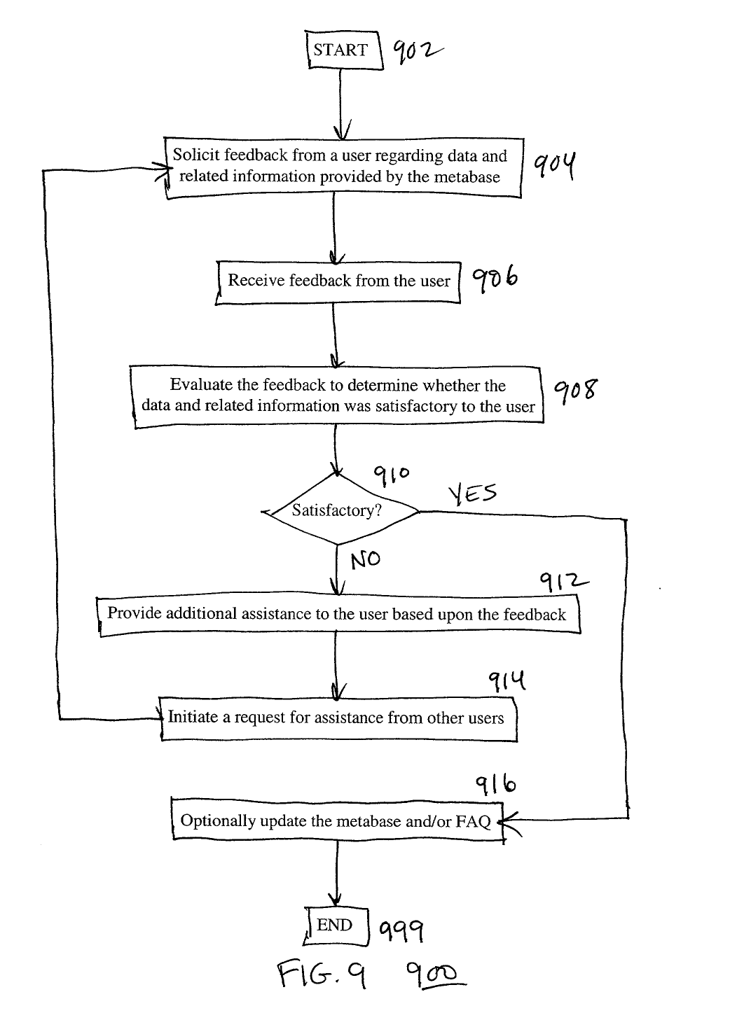

FIG. 9 is a logic flow diagram showing exemplary logic 900 for soliciting feedback and providing additional assistance by the metabase. Beginning at step 902, the logic solicits feedback from a user regarding data and related information provided by the metabase, in step 904. Upon receiving feedback from the user, in step 906, the logic evaluates the feedback to determine whether the data and related information received by the user was satisfactory to the user, in step 908. If the data and related information retrieved by the user was unsatisfactory (NO in step 910), then the logic may provide additional assistance to the user based upon the feedback, in step 912, for example, by referring the user to someone who can provide additional information. The logic may also initiate a request for assistance from other users, in step 914. The logic may recycle to step 904 to solicit additional feedback from the user regarding any additional data and related information provided to the user. Once the user indicates that the data and related information received from the metabase was satisfactory (YES in step 910), then the logic may update the metabase and/or the FAQs, in step 916. The logic 900 terminates in step 999.

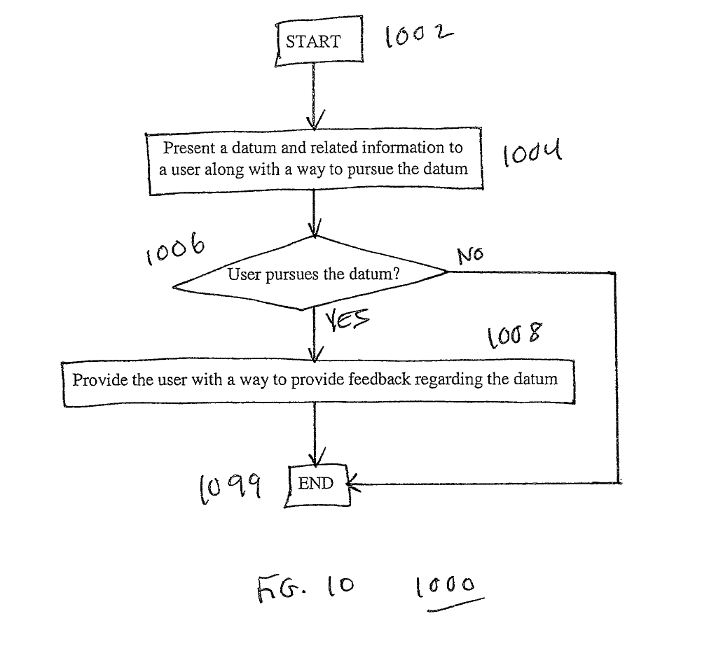

FIG. 10 is a logic flow diagram showing exemplary logic 1000 for determining whether a user is actively pursuing a datum (i.e. interested in providing feedback at a later date or to receive future updates). Beginning at step 1002, the logic presents a datum and related information to a user along with a way for the user to actively pursue the datum (e.g., a “pursue it” click button), in step 1004. If the user decides to pursue the datum (YES in step 1006), then the logic provides the user with a way to provide feedback regarding the datum, in step 1008, for example, by presenting an on-line form or sending an email to the user. If the user decides not to pursue the datum (NO in step 1006), then the logic does not provide the user with a way to provide feedback. The logic 1000 terminates in step 1099.

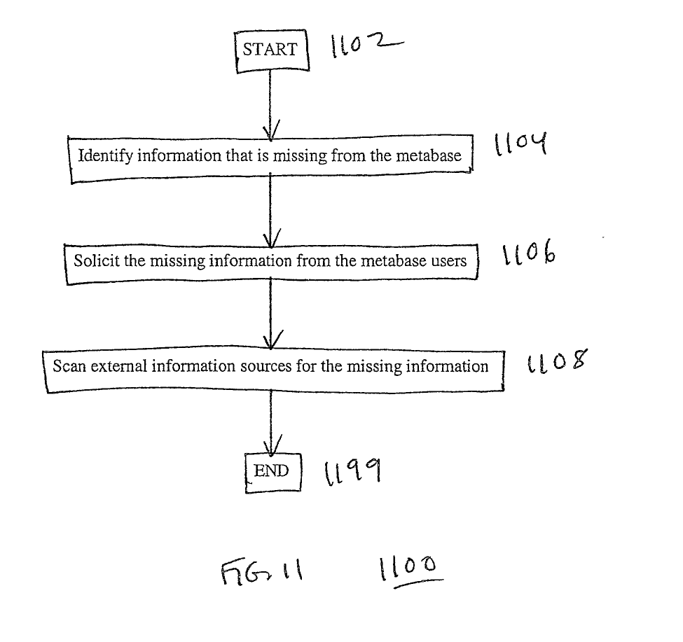

FIG. 11 is a logic flow diagram showing exemplary logic 1100 for obtaining missing information by the metabase. Beginning at step 1102, the logic identifies information that is missing from the metabase, in step 1104, for example, by searching the metabase for fields that have been left blank. The logic may solicit the missing information from the metabase users, in step 1106. The logic may also scan external information sources for the missing information, in step 1108. The logic 1100 terminates in step 1199. It should be noted that fields can be made compulsory such that a metabase record is not created unless and until the information is provided.

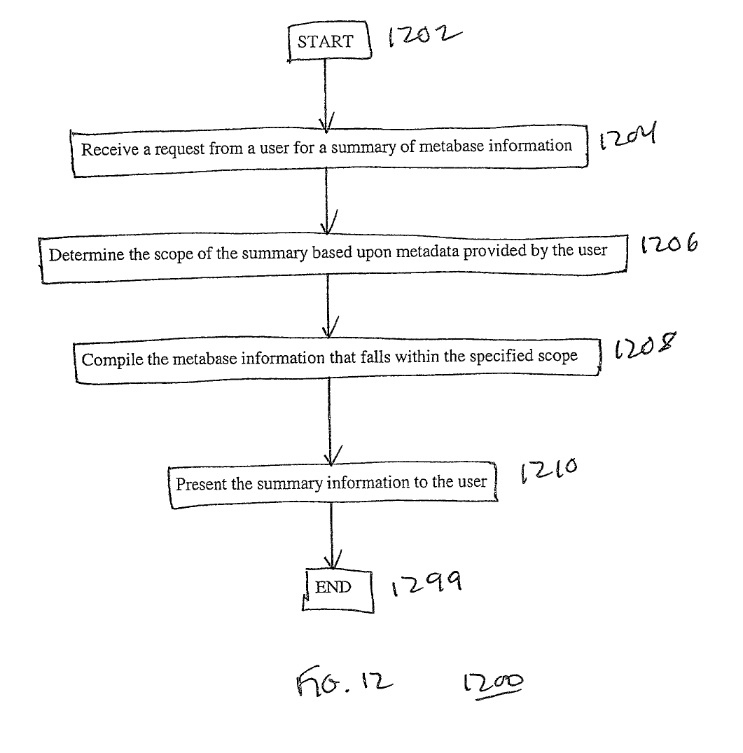

FIG. 12 is a logic flow diagram showing exemplary logic 1200 for summarizing metabase information by the metabase. Beginning at step 1202, and upon receiving a request from a user for a summary of metabase information, in step 1204, the logic determines the scope of the summary based upon metadata provided by the user, in step 1206. The logic then compiles the metabase information that falls within the specified scope, in step 1208, and presents the summary information to the user, in step 1210. The logic 1200 terminates in step 1299.

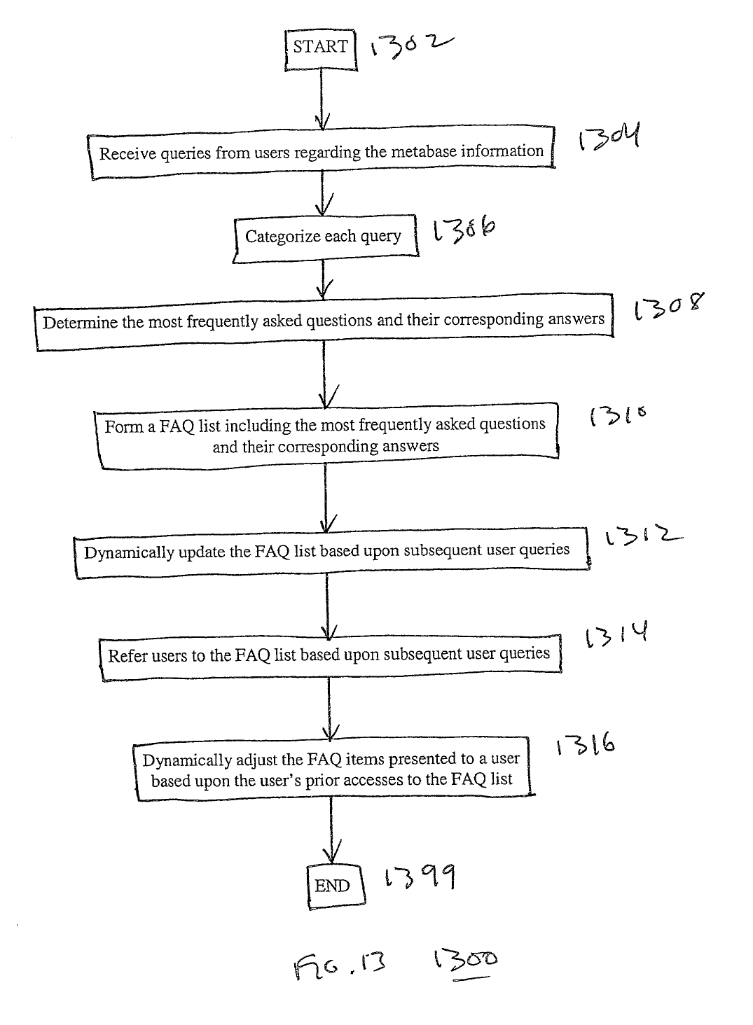

FIG. 13 is a logic flow diagram showing exemplary logic 1300 for automatically creating a FAQ list by the metabase. The logic begins at step 1302. The logic receives queries from users regarding the metabase information, in step 1304. The logic categorizes each query, in step 1306, specifically to identify queries that are posed repeatedly. This can be done, for example, using keywords or specific fields chosen for the search. The logic determines the most frequently asked questions and their corresponding answers (such as by asking users to provide a link to the metabase record that provides the answer), in step 1308, and forms a FAQ list including the most frequently asked questions and their corresponding answers, in step 1310. The logic dynamically updates the FAQ list based upon subsequent user queries, in step 1312. The logic refers users to the FAQ list based upon subsequent user queries, in step 1314. The logic dynamically adjusts the FAQ items presented to a user based upon the user's prior accesses to the FAQ list, in step 1316. The logic 1300 terminates in step 1399.

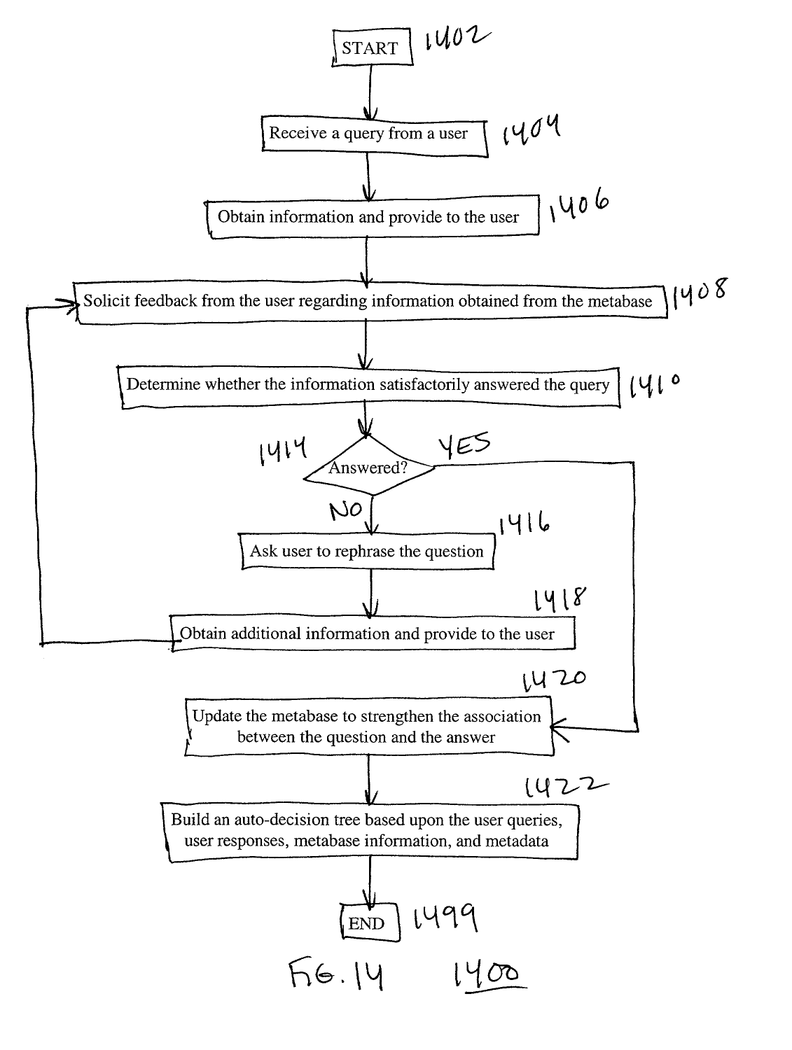

FIG. 14 is a logic flow diagram showing exemplary logic 1400 for automatically creating an auto-decision tree by the metabase. Beginning at step 1402, the logic receives a query from a user, in step 1404. The logic obtains information and provides the information to the user, in step 1406. The logic can obtain the information from a variety of sources, including retrieving information from the metabase and monitoring responses from other users. The logic solicits feedback from the user regarding information obtained from the metabase, in step 1408, and determines whether the information satisfactorily answered the query, in step 1410. If the information did not satisfactorily answer the query (NO in step 1414), then the logic may ask the user to rephrase the question, in step 1416, and may obtain additional information and provide the additional information to the user, in step 1418. The logic may recycle to step 1408 to solicit additional feedback from the user. Once the user indicates that the information satisfactorily answered the query (YES in step 1414), the logic may update the metabase to strengthen the association between the question and the answer, in step 1420. The logic may also build an auto-decision tree based upon the user queries, user responses, metabase information, and metadata, in step 1422. The logic 1400 terminates in step 1499.

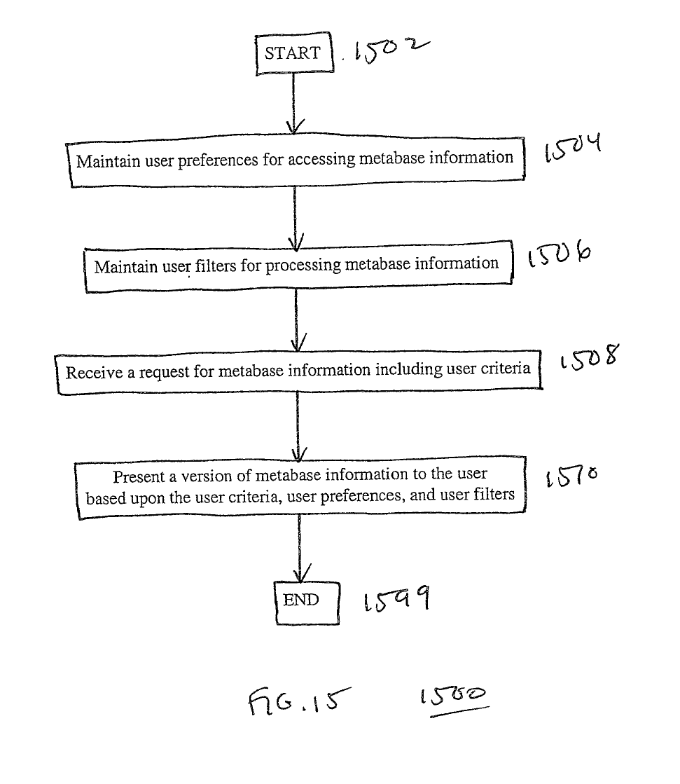

FIG. 15 is a logic flow diagram showing exemplary logic 1500 for presenting information to a user by the metabase. Beginning at step 1502, the logic maintains user preferences for accessing metabase information, in step 1504, and also maintains user filters for processing metabase information, in step 1506. Upon receiving a request for metabase information including user criteria for retrieving the metabase information, in step 1508, the logic presents a version of the metabase information to the user based upon the user criteria, user preferences, and user filters, in step 1510. The logic 1500 terminates in step 1599.

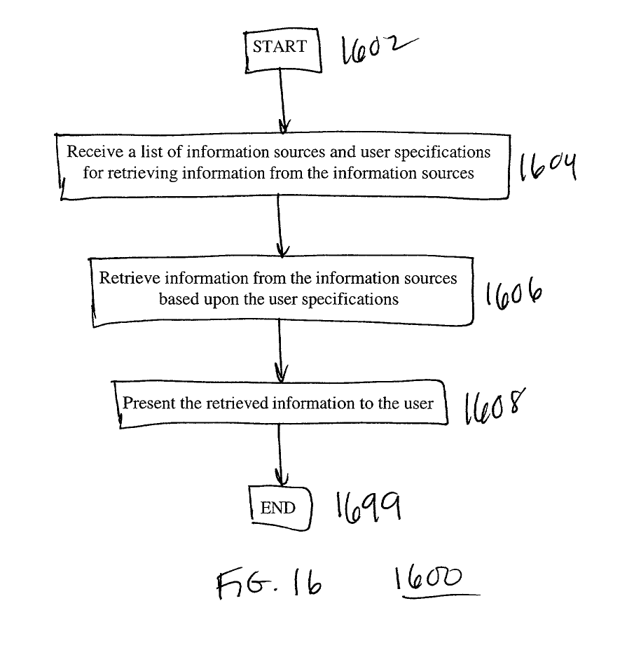

FIG. 16 is a logic flow diagram showing exemplary logic 1600 for compiling information from multiple information sources by a metabrowser. Beginning at step 1602, the logic receives a list of information sources and user specifications for retrieving information from the information sources, in step 1604. The list may come from a variety of sources, such as from a user or from a query of a metabase that lists descriptions of other metabases and possibly searches multiple metabases at once (in a manner similar to a on-line music service that searches user computers for songs of interest). The logic proceeds to retrieve information from the information sources based upon the user specifications, in step 1606. The logic can present the retrieved information to the user, in step 1608. The logic can present the retrieved information to the user in any of a variety of forms, such as creating a custom web page containing the retrieved information or exporting the retrieved information to an external application (e.g., spreadsheet or word processor). The logic 1600 terminates in step 1699.

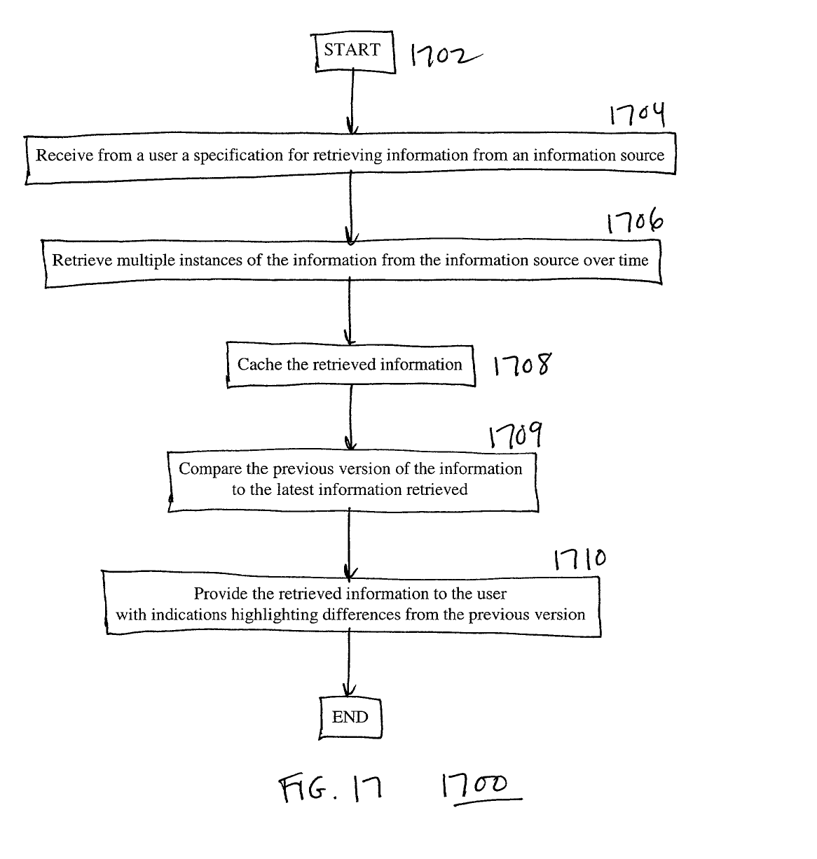

FIG. 17 is a logic flow diagram showing exemplary logic 1700 for providing page versioning by a metabrowser. Beginning at step 1702, the logic receives from a user a specification for retrieving information from an information source, in step 1704. The logic proceeds to retrieve multiple instances of the information from the information source over time, in step 1706, and caches the retrieved information, in step 1708. The logic compares the previous version of the information to the latest information retrieved, in step 1709. The logic provides the retrieved information to the user with indications highlighting differences from the previous version, in step 1710. The logic 1700 terminates in step 1799.

It should be noted that the metabase can be “auto-versioning” such that every time a record is edited, the previous version of the record is stored. Then, a user can view the differences between any two incarnations of the record at any time or view cumulative changes over time.

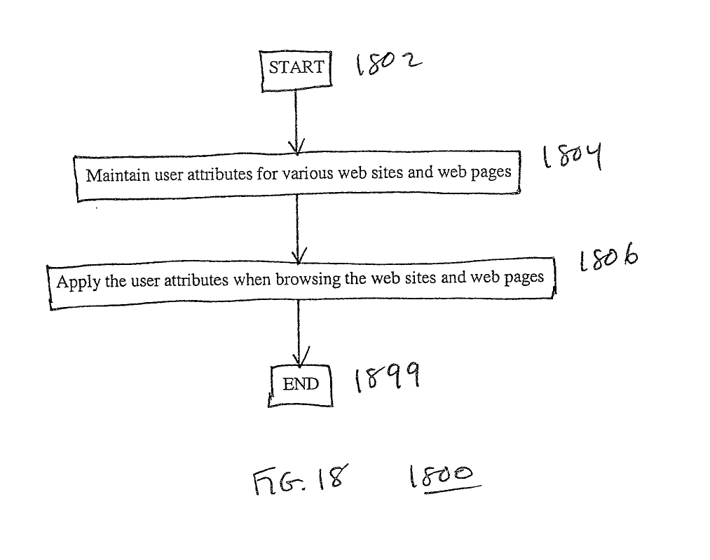

FIG. 18 is a logic flow diagram showing exemplary logic 1800 for supporting user attributes by a metabrowser. Beginning at step 1802, the logic maintains user attributes for various web sites and web pages, in step 1804. The logic applies the user attributes when browsing the web sites and web pages, in step 1806. The logic 1800 terminates in step 1899.

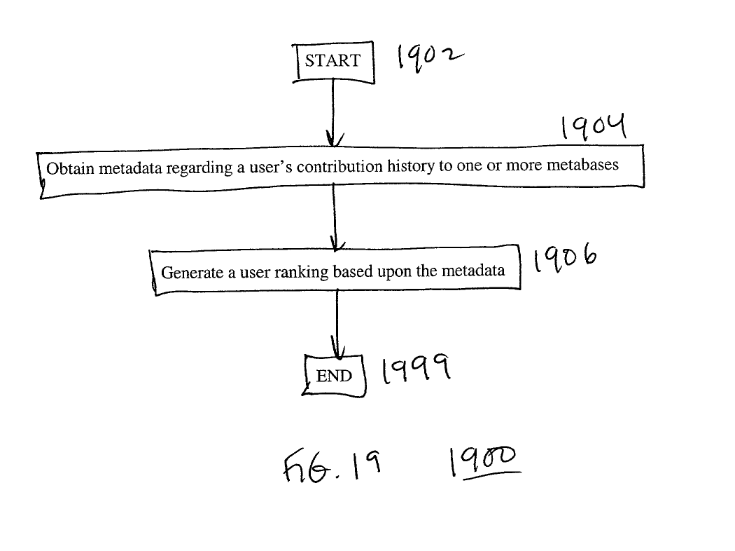

FIG. 19 is a logic flow diagram showing exemplary logic 1900 for generating a user ranking by the ranking authority. Beginning in step 1902, the logic obtains metadata regarding a user's contribution history to one or more metabases, in step 1904, and generates a user ranking based upon the metadata, in step 1906. The logic 1900 terminates in step 1999.

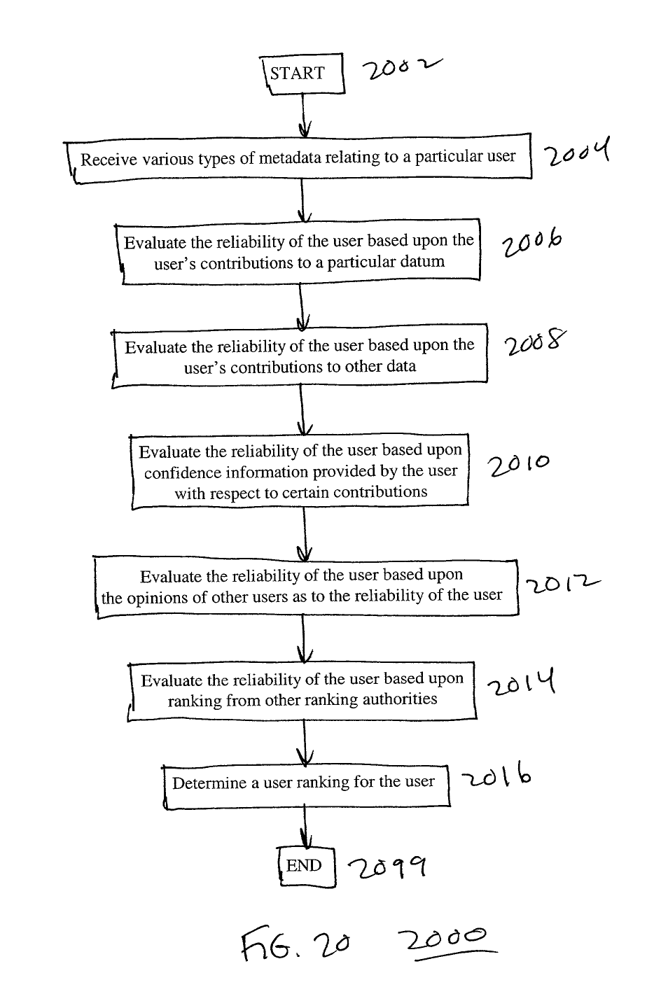

FIG. 20 is a logic flow diagram showing exemplary logic 2000 for determining a user ranking by the ranking authority. Beginning at step 2002, the logic receives various types of metadata relating to a particular user, in step 2004. The logic may evaluate the reliability of the user based upon the user's contributions to a particular datum, in block 2006, for example, by determining the reliability of the datum and determining the reliability of the user based upon the reliability of the datum. The logic may evaluate the reliability of the user based upon the user's contributions to other data, in block 2008, for example, by evaluating the user's history of contributions to one or more metabases. The logic may evaluate the reliability of the user based upon confidence information provided by the user with respect to certain contributions, in block 2010, for example, a history of honest self-assessments may lead the logic to trust the user's future self-assessments with regard to a particular datum. The logic may evaluate the reliability of the user based upon the opinions of other users as to the reliability of the user, in block 2012. The logic may evaluate the reliability of the user based upon rankings from other ranking authorities, in block 2014. The logic determines a user ranking for the user based upon the metadata and the different evaluations made therefrom, in step 2016. The logic 2000 terminates in step 2099.

It should be noted that there is typically not a single “user ranking,” but instead a user might be in a number of different areas such as metabases covering different topics or along different axes such as “likelihood of making positive assertions that turn out to be false” and “likelihood of giving incomplete information.” Other axes might indicate, say, the user's reliability with regard to a particular subject.

It should be noted that the present invention is in no way limited to Internet applications. The present invention may be embodied in various other applications, including, among other things, public and private network applications, local non-network machines, and portable devices, to name but a few.

Furthermore it should be noted that the present invention is in no way limited to a particular number or type of users. A workgroup may comprise from 1 to an unlimited number of participants and may take the form of private groups, public groups, and groups of indeterminate composition, including non-human participants, including but not limited to “bots,” “spiders,” other agents or other metabases.

It should be noted that the logic flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In a typical embodiment of the present invention, predominantly all of the metabase logic is implemented as a set of computer program instructions that is converted into a computer executable form, stored as such in a computer readable medium, and executed by a microprocessor within the metabase under the control of an operating system. Such logic may be used in a variety of user platforms, including personal computers and handheld devices such as personal digital assistants (PDAs) and various wireless handheld devices.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Perl, Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

Database program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various database query languages (e.g., an object code, an assembly language, or a high-level language, including but not limited to structured query languages (SQL) such as that implemented by mySQL, mSQL, Oracle, Microsoft Access, or any flat file or relational database software) for use with various operating systems or operating environments. The database source code may define and use various data structures and communication messages. The database source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies, networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The present invention may be embodied in other specific forms without departing from the true scope of the invention. The described embodiments are to be considered in all respects only as illustrative and not restrictive.

What is claimed is:

1. A collaborative information system comprising a metadata-enhanced database (metabase) for recording data and related metadata and for enabling a metabase user to assess the reliability of the data and other metabase users based upon the metadata.

2. The collaborative information system of claim 1, wherein the reliability of the data is assessed by evaluating the reliability of its contributors and the reliability of the contributors is assessed by evaluating the reliability of the data.

3. The collaborative information system of claim 1, wherein the metabase is populated and maintained by the metabase users.

4. The collaborative information system of claim 1, wherein the metabase comprises automated versioning means for tracking and maintaining a history of each datum recorded in the metabase.

5. The collaborative information system of claim 1, wherein the metabase comprises notification means for notifying interested metabase users regarding metabase changes.

6. The collaborative information system of claim 1, wherein the metabase comprises information gathering means for obtaining information from various sources.

7. The collaborative information system of claim 1, wherein the metabase comprises reliability assessment means for assessing the reliability of the data and the metabase users.

8. The collaborative information system of claim 1, wherein the metabase comprises automated help means for resolving metabase user queries.

9. The collaborative information system of claim 1, wherein the metabase comprises customizable retrieval means for enabling a metabase user to specify various criteria for retrieving data.

10. The collaborative information system of claim 1, wherein the metadata comprises at least one of:
user identification information;
user personal information;
user performance information;
information characterization information;
contributor information;
source (citation) information;
feedback information;
implicit information;
historical information;
user rankings obtained from one or more ranking authorities;
opinion information from contributors and users of the data regarding the reliability of the data and the users; and
solicited information regarding the reliability of the data and the users.

11. The collaborative information system of claim 1, wherein the metabase comprises browser means for interacting with web-based entities.

12. The collaborative information system of claim 1, wherein the metabase uses an editable data markup language for creating and using the metabase, wherein the editable data markup language comprises:
means for defining a metabase structure;
means for editing the metabase structure;
means for contributing information to metabase structure;
means for retrieving information from the metabase structure;
means for combining data from multiple metabases; and
means for automatically updating one metabase from another metabase.

13. A ranking authority for generating a user ranking based upon user contributions to a metadata-enhanced database, the ranking authority comprising:
means for evaluating the reliability of a user based upon metadata relating to the user's contributions to a metadata-enhanced database; and
means for generating a user ranking representing the reliability of the user; and
means for updating the user ranking based upon additional metadata.

14. A metadata-enhanced robot for linking to a metadata-enhanced database, the metadata-enhanced robot comprising means for retrieving information from the metadata-enhanced database.
